(19) United States
(12) Patent Application Publication
(10) Pub. No.: US 2026/0253385 A1
(43) Pub. Date: Aug. 27, 2026

(54) SYSTEM

(71) Applicant: SoftBank Group Corp., Tokyo (JP)

(72) Inventor: Hiroyuki NISHIDA, Tokyo (JP)

(73) Assignee: SoftBank Group Corp., Tokyo (JP)

(21) Appl. No.: 19/537,531

(22) Filed: Feb. 12, 2026

(30) Foreign Application Priority Data
Feb. 21, 2025 (JP) 2025-027071

(51) Int. Cl. G06V 10/764; G06F 40/30

(52) U.S. Cl. CPC G06V 10/764; G06F 40/30

(57) ABSTRACT

The system according to the embodiment comprises an acquisition unit, an analysis unit, and a provision unit. The acquisition unit acquires a video of the user's tooth brushing. The analysis unit analyzes the video acquired by the acquisition unit. The provision unit provides the analysis result obtained by the analysis unit to the user.

### CROSS-REFERENCE TO RELATED APPLICATION

The present application claims priority to and incorporates by reference the entire contents of Japanese Patent Application No. 2025-027071 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, it has been difficult for users to accurately grasp the condition of their own tooth brushing, and there is room for improvement.

### SUMMARY OF THE INVENTION

The system according to the embodiment comprises an acquisition unit, an analysis unit, and a provision unit. The acquisition unit acquires a video of the user's tooth brushing. The analysis unit analyzes the video acquired by the acquisition unit. The provision unit provides the analysis result obtained by the analysis unit to the user.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

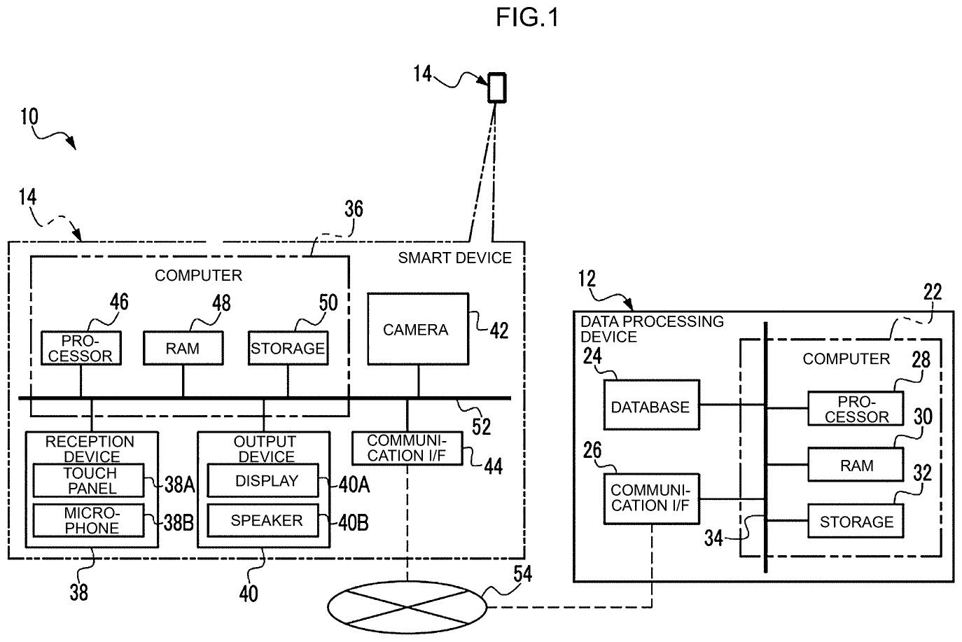

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

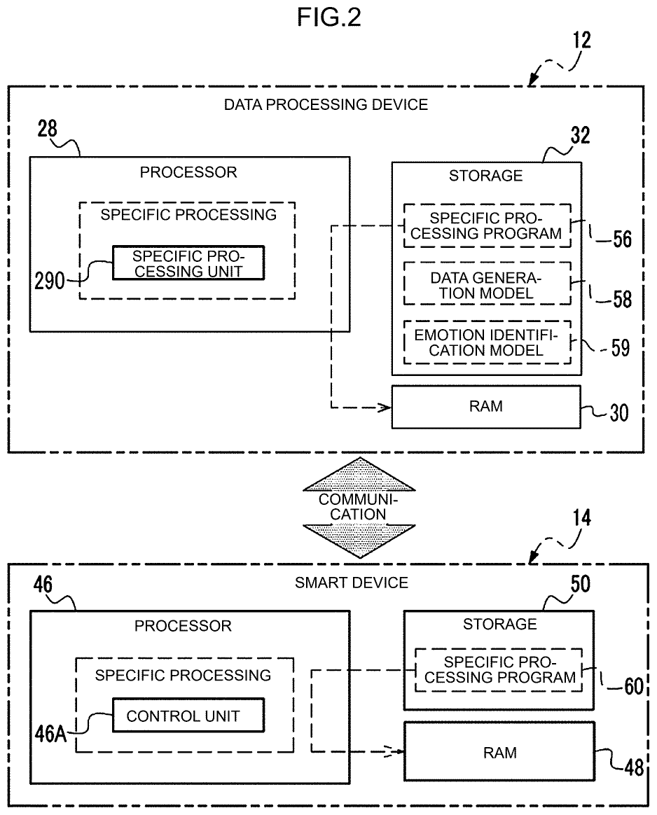

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The tooth brushing support system according to the embodiment of the present invention is a system that analyzes areas that are not properly brushed and gently informs the user, simply by having the user brush their teeth in front of a smartphone camera. When the user brushes their teeth in front of the smartphone camera, an AI analyzes the camera footage and identifies unbrushed areas. The AI gently informs the user of the identified unbrushed areas. Furthermore, when the user brushes properly, the AI praises the user. With this mechanism, users can enjoy brushing their teeth and maintain healthy teeth. For example, the user brushes their teeth in front of the smartphone camera. At this time, the smartphone camera captures the inside of the user's mouth and transmits the video to the AI in real time. For instance, the camera captures the user brushing their teeth with a toothbrush, and this video is input to the AI. Next, the AI analyzes the input video. The AI analyzes the condition of the user's teeth from the video and identifies unbrushed areas. For example, the AI detects dirt or stains on the surface of the teeth and identifies unbrushed areas. This analysis result is fed back to the user. The AI gently informs the user of the identified unbrushed areas. For example, the AI displays a message such as “The upper right molar has not been brushed yet.” This allows the user to know which areas should be brushed more thoroughly. Furthermore, when the user brushes properly, the AI praises the user. For example, the AI displays a message such as “You brushed very well!” This increases the user's motivation for tooth brushing. With this mechanism, users can enjoy brushing their teeth and maintain healthy teeth. For example, even if a child dislikes brushing their teeth, the AI gently instructs them, making tooth brushing enjoyable. Also, for adults concerned about stains or bad breath, the AI provides appropriate advice, helping them maintain healthy teeth. As a result, the tooth brushing support system enables users to enjoy brushing their teeth and maintain healthy teeth. Specifically, the tooth brushing support system receives intraoral video data obtained from a smartphone camera (for example, RGB image tensor: shape [batch size, height, width, number of channels], e.g., 1, 720, 1280, 3) as input data from the acquisition unit. The system performs preprocessing on the video data (e.g., detection of face and oral regions, noise removal, contrast adjustment, segmentation of tooth regions, etc.) and inputs the obtained tooth region image to the analysis unit. The analysis unit uses image analysis models such as convolutional neural networks (CNN) or Vision Transformers to estimate, at the pixel level, the presence of dirt or stains on the tooth surface and the location of unbrushed areas. The AI model outputs a binary mask of unbrushed areas (e.g., shape [height, width], values are 0 or 1), an unbrushed area score map (probability value for each pixel), and labels for each tooth (e.g., “Upper right molar: unbrushed” etc.). For example, output examples such as “Upper right molar: 0.85 (unbrushed probability)” and “Lower left incisor: 0.10 (unbrushed probability)” can be obtained. These outputs are passed to the subsequent provision unit, which generates natural language messages such as “The upper right molar has not been brushed yet” or images highlighting the unbrushed areas on the user interface. Furthermore, when the user brushes sufficiently (for example, when the unbrushed probability for all teeth is below 0.2, as determined by a threshold), the provision unit generates praising messages such as “You brushed very well!” and notifies the user via speech synthesis or text display. For training the AI model, actual tooth brushing videos and annotation data of unbrushed areas by dentists are used, and the weights are optimized using loss functions such as cross-entropy loss or Dice loss. As a result, the system can identify unbrushed areas with high accuracy and speed from vast amounts of video data, without relying on human visual inspection or empirical rules. The technical effect is that the system enables automatic detection of subtle unbrushed areas and automatic generation of feedback optimized for each user, which was difficult with conventional human visual inspection or simple rule-based judgment, thereby contributing to the improvement of tooth brushing habits and maintenance of oral health. Application fields include home tooth brushing support apps, tooth brushing education for children, self-care guidance at dental clinics, and oral care support in nursing care settings.

The tooth brushing support system according to the embodiment comprises an acquisition unit, an analysis unit, and a provision unit. The acquisition unit acquires a video of the user's tooth brushing. The user's tooth brushing video may include, for example, video, still images, real-time footage, etc., but is not limited thereto. The acquisition unit may, for example, use a smartphone camera to capture the inside of the user's mouth. The smartphone camera may be a front camera, rear camera, or have various resolutions, but is not limited thereto. The analysis unit analyzes the video acquired by the acquisition unit. The analysis unit uses AI to analyze the condition of the user's teeth from the video and identify unbrushed areas. The analysis may include, for example, image analysis algorithms, AI technologies, etc., but is not limited thereto. The provision unit provides the analysis result obtained by the analysis unit to the user. The provision unit gently informs the user of the identified unbrushed areas. The provision may include, for example, notification methods, display formats, etc., but is not limited thereto. For example, the provision unit may use voice feedback or text feedback when notifying the user of the analysis result. Thus, the tooth brushing support system according to the embodiment enables the user to brush their teeth appropriately. Some or all of the above-described processing in the provision unit may be performed using AI or without using AI. For example, the provision unit may input the analysis result to the AI, and the AI may generate a message to notify the user based on the analysis result. Specifically, the tooth brushing support system receives intraoral video data obtained from a smartphone camera (for example, RGB image tensor: shape [batch size, height, width, number of channels], e.g., 1, 720, 1280, 3) as input data to the acquisition unit. The system performs preprocessing on the video data (e.g., detection of face and oral regions, noise removal, contrast adjustment, segmentation of tooth regions, etc.) and inputs the obtained tooth region image to the analysis unit. The analysis unit uses image analysis models such as convolutional neural networks (CNN) or Vision Transformers to estimate, at the pixel level, the presence of dirt or stains on the tooth surface and the location of unbrushed areas. Input examples for the AI model include 720×1280 pixel color images or sequences of video frames (e.g., 5 seconds of video at 30 frames per second). The AI model outputs a binary mask of unbrushed areas (e.g., shape [height, width], values are 0 or 1), an unbrushed area score map (probability value for each pixel), and labels for each tooth (e.g., “Upper right molar: unbrushed” etc.). For example, output examples such as “Upper right molar: 0.85 (unbrushed probability)” and “Lower left incisor: 0.10 (unbrushed probability)” can be obtained. These outputs are passed to the subsequent provision unit, which generates natural language messages such as “The upper right molar has not been brushed yet” or images highlighting the unbrushed areas on the user interface. Furthermore, when the user brushes sufficiently (for example, when the unbrushed probability for all teeth is below 0.2, as determined by a threshold), the provision unit generates praising messages such as “You brushed very well!” and notifies the user via speech synthesis or text display. For training the AI model, actual tooth brushing videos and annotation data of unbrushed areas by dentists are used, and the weights are optimized using loss functions such as cross-entropy loss or Dice loss. As a result, the system can identify unbrushed areas with high accuracy and speed from vast amounts of video data, without relying on human visual inspection or empirical rules. The technical effect is that the system enables automatic detection of subtle unbrushed areas and automatic generation of feedback optimized for each user, which was difficult with conventional human visual inspection or simple rule-based judgment, thereby contributing to the improvement of tooth brushing habits and maintenance of oral health. Application fields include home tooth brushing support apps, tooth brushing education for children, self-care guidance at dental clinics, and oral care support in nursing care settings.

The tooth brushing support system comprises a specifying unit configured to identify unbrushed areas. The specifying unit uses AI to identify unbrushed areas from the user's tooth brushing video. Unbrushed areas may include, for example, dirt or stains on the surface of the teeth, but are not limited thereto. The specifying unit may, for example, have the AI analyze the video and detect dirt or stains on the surface of the teeth. The AI can identify dirt or stains on the surface of the teeth from the video and identify unbrushed areas. By identifying unbrushed areas, the user can know which areas should be brushed more thoroughly. Some or all of the above-described processing in the specifying unit may be performed using AI or without using AI. For example, the specifying unit may input the video to the AI, and the AI may identify unbrushed areas. Specifically, the specifying unit of the tooth brushing support system receives intraoral video data obtained from a smartphone camera (for example, RGB image tensor: shape 1, 720, 1280, 3) as input data. The specifying unit performs preprocessing on the video data (detection of face and oral regions, noise removal, contrast adjustment, segmentation of tooth regions, etc.) and inputs the obtained tooth region image to image analysis models such as convolutional neural networks (CNN) or Vision Transformers. The specifying unit can input, for example, 720×1280 pixel color images or sequences of video frames (5 seconds of video at 30 frames per second) to these AI models. The specifying unit obtains, as output from the AI model, a binary mask of unbrushed areas (shape 720, 1280, values are 0 or 1), an unbrushed area score map (probability value for each pixel), and labels for each tooth (e.g., “Upper right molar: unbrushed” etc.). For example, output examples such as “Upper right molar: 0.85 (unbrushed probability)” and “Lower left incisor: 0.10 (unbrushed probability)” can be obtained. The specifying unit can pass these outputs to the subsequent provision unit or feedback unit. For training the AI model, actual tooth brushing videos and annotation data of unbrushed areas by dentists are used, and the weights are optimized using loss functions such as cross-entropy loss or Dice loss. Unlike conventional human visual inspection or simple rule-based judgment, the specifying unit uses feature extraction in high-dimensional space and unconventional image analysis techniques to achieve automatic detection of subtle unbrushed areas. The specifying unit can use the identification results of unbrushed areas for threshold judgment or branching processing, and utilize them as triggers for generating feedback or praising messages optimized for each user. The technical effect is that the specifying unit can identify unbrushed areas with high accuracy and speed from vast amounts of video data, contributing to the improvement of users' tooth brushing habits and maintenance of oral health. Application fields include home tooth brushing support apps, tooth brushing education for children, self-care guidance at dental clinics, and oral care support in nursing care settings.

The tooth brushing support system comprises a feedback unit configured to provide feedback to the user. The feedback unit uses AI to provide feedback to the user. Feedback may include, for example, voice feedback, text feedback, etc., but is not limited thereto. The feedback unit may, for example, have the AI generate a message to notify the user based on the analysis result. The AI can generate a message to inform the user which areas should be brushed more thoroughly based on the analysis result. By providing feedback, the user can brush their teeth appropriately. Some or all of the above-described processing in the feedback unit may be performed using AI or without using AI. For example, the feedback unit may input the analysis result to the AI, and the AI may generate a feedback message. Specifically, the feedback unit receives, as input data, the binary mask of unbrushed areas, score map, and labels for each tooth (e.g., “Upper right molar: 0.85” etc.) received from the analysis unit. The feedback unit can input these structured data to a natural language generation model (for example, a Transformer-based large language model) and generate personalized text messages for the user, such as “The upper right molar has not been brushed yet” or “The lower left incisor is clean.” The feedback unit can also input the generated text message to a speech synthesis module and notify the user as voice feedback. For example, output examples include “The probability of unbrushed area on the upper right molar is high, so please brush it again” or “Overall, your teeth are clean.” The feedback unit can refer to the user's past tooth brushing history and emotion estimation results to dynamically adjust the feedback content and expression method. For training the AI model, actual user feedback history and examples of guidance by dentists are used, and the weights are optimized using loss functions such as cross-entropy loss or BLEU score. Unlike conventional static notifications or simple rule-based message generation, the feedback unit automatically generates natural language feedback optimized for each user, thereby improving user understanding and motivation. The technical effect is that the feedback unit enables users to intuitively understand which areas should be brushed more thoroughly, contributing to the improvement of tooth brushing habits and maintenance of oral health. Application fields include home tooth brushing support apps, tooth brushing education for children, self-care guidance at dental clinics, and oral care support in nursing care settings.

The tooth brushing support system comprises a praising unit configured to praise the user. The praising unit uses AI to praise the user. Praising may include, for example, the content of praise, timing of praise, etc., but is not limited thereto. The praising unit may, for example, have the AI generate a message to praise the user based on the analysis result. The AI can generate a message to praise the user when the user brushes properly. By praising the user, the user's motivation for tooth brushing can be increased. Some or all of the above-described processing in the praising unit may be performed using AI or without using AI. For example, the praising unit may input the analysis result to the AI, and the AI may generate a praising message. Specifically, the praising unit receives, as input data, the score map of unbrushed areas and labels for each tooth (e.g., “Upper right molar: 0.05” etc.) received from the analysis unit. The praising unit performs threshold judgment, such as determining that the probability of unbrushed areas for all teeth is below 0.2, and when the condition is met, generates praising messages such as “You brushed very well!” or “Perfect again today!” The praising unit uses a natural language generation model to refer to the user's past tooth brushing history and emotion estimation results, and can personalize the content and timing of praise. The praising unit can input the generated praising message to a speech synthesis module and notify the user by voice or text. For example, output examples include “The upper right molar is also clean. Excellent!” or “You have improved compared to yesterday!” For training the AI model, user motivation improvement history and examples of praise by dentists are used, and the weights are optimized using loss functions such as cross-entropy loss or emotion estimation accuracy. Unlike conventional static praise or simple rule-based judgment, the praising unit automatically generates praising messages optimized for each user, thereby contributing to the continuation of tooth brushing habits and improvement of motivation. The technical effect is that the praising unit promotes behavioral change in users and contributes to the maintenance of health and establishment of tooth brushing habits. Application fields include home tooth brushing support apps, tooth brushing education for children, self-care guidance at dental clinics, and oral care support in nursing care settings.

The acquisition unit can capture the inside of the user's mouth using a smartphone camera. The acquisition unit uses a smartphone camera to capture the inside of the user's mouth. The smartphone camera may be a front camera, rear camera, or have various resolutions, but is not limited thereto. The acquisition unit may, for example, use the front camera of the smartphone to capture the inside of the user's mouth. The front camera is suitable for the user to hold the smartphone and capture the inside of their mouth. The acquisition unit can also use the rear camera of the smartphone to capture the inside of the user's mouth. The rear camera is suitable for capturing the inside of the mouth with the smartphone fixed in place. Furthermore, the acquisition unit can adjust the resolution of the smartphone camera to obtain detailed images of the inside of the mouth. By using the smartphone camera, the inside of the user's mouth can be accurately captured. Some or all of the above-described processing in the acquisition unit may be performed using AI or without using AI. For example, the acquisition unit may input the video captured by the smartphone camera to the AI, and the AI may analyze the video. Specifically, the acquisition unit acquires RGB image tensors obtained from the smartphone camera (e.g., shape 1, 720, 1280, 3) or sequences of video frames (e.g., 5 seconds of video at 30 frames per second) as input data. The acquisition unit dynamically controls parameters such as camera type (front/rear), resolution (e.g., 720p, 1080p, 4K), frame rate, exposure, and white balance to optimally capture the condition inside the user's mouth. During video acquisition, the acquisition unit uses face detection algorithms (e.g., Haar Cascade, MTCNN) or oral region detection models (e.g., YOLO, SSD) to determine in real time whether the oral region is sufficiently captured in the frame, and if not, displays guidance to the user such as “Please tilt the camera up a little more.” During video acquisition, the acquisition unit performs preprocessing such as noise removal (e.g., Gaussian filter), contrast adjustment, and color space conversion (e.g., RGB to Lab) to generate high-quality image data for maximizing the accuracy of subsequent AI analysis. The acquisition unit can transfer the acquired video data to the analysis unit or specifying unit in streaming format, and implements adaptive streaming control that automatically adjusts resolution and frame rate according to communication bandwidth and buffering status during transfer. Input examples for AI include 720×1280 pixel color images, sequences of video frames, or cropped image tensors of only the oral region. By acquiring such high-quality video data, the subsequent AI analysis unit can accurately identify the condition of the teeth and unbrushed areas, greatly improving the detection accuracy of subtle dirt or stains that was difficult with conventional human visual inspection or low-resolution images. The technical effect is that the acquisition unit can stably acquire high-quality intraoral video data optimized for each user and environment by combining multiple technical elements such as camera control, preprocessing, region detection, and streaming optimization, thereby dramatically improving the accuracy, speed, and reliability of AI analysis. Application fields include home tooth brushing support apps, tooth brushing education for children, self-care guidance at dental clinics, oral care support in nursing care settings, and remote medical monitoring of oral conditions.

The analysis unit can analyze the condition of the user's teeth from the video and identify unbrushed areas. The analysis unit uses AI to analyze the condition of the user's teeth from the video and identify unbrushed areas. The condition of the teeth may include, for example, oral health status, degree of dirt, etc., but is not limited thereto. The analysis unit may, for example, have the AI analyze the video and detect dirt or stains on the surface of the teeth. The AI can identify dirt or stains on the surface of the teeth from the video and identify unbrushed areas. By analyzing the condition of the teeth from the video, unbrushed areas can be identified. Some or all of the above-described processing in the analysis unit may be performed using AI or without using AI. For example, the analysis unit may input the video to the AI, and the AI may analyze the condition of the teeth. Specifically, the analysis unit receives intraoral RGB image tensors (e.g., shape 1, 720, 1280, 3) or sequences of video frames (e.g., 5 seconds of video at 30 frames per second) obtained from a smartphone camera as input data. The analysis unit first extracts the oral region from the video using face detection algorithms (e.g., MTCNN) or oral region detection models (e.g., YOLO). Next, preprocessing such as noise removal (Gaussian filter), contrast adjustment, and color space conversion (RGB to Lab) is performed, and segmentation of the tooth region is carried out. The obtained tooth region image is input to image analysis models such as convolutional neural networks (CNN) or Vision Transformers. The AI model estimates, at the pixel level, the presence of dirt or stains on the tooth surface and the location of unbrushed areas. Input examples for AI include 720×1280 pixel color images or cropped image tensors of only the oral region. The AI model outputs a binary mask of unbrushed areas (shape 720, 1280, values are 0 or 1), an unbrushed area score map (probability value for each pixel), and labels for each tooth (e.g., “Upper right molar: unbrushed” etc.). For example, output examples such as “Upper right molar: 0.85 (unbrushed probability)” and “Lower left incisor: 0.10 (unbrushed probability)” can be obtained. These outputs are passed to the subsequent provision unit or feedback unit and used for notification or advice generation for the user. For training the AI model, actual tooth brushing videos and annotation data of unbrushed areas by dentists are used, and the weights are optimized using loss functions such as cross-entropy loss or Dice loss. Unlike conventional human visual inspection or simple rule-based judgment, the analysis unit uses feature extraction in high-dimensional space and unconventional image analysis techniques to achieve automatic detection of subtle unbrushed areas. The technical effect is that the analysis unit can identify unbrushed areas with high accuracy and speed from vast amounts of video data, contributing to the improvement of users' tooth brushing habits and maintenance of oral health. Application fields include home tooth brushing support apps, tooth brushing education for children, self-care guidance at dental clinics, and oral care support in nursing care settings.

The provision unit can notify the user of the identified unbrushed areas. The provision unit uses AI to notify the user of the identified unbrushed areas. Notification may include, for example, notification format, notification timing, etc., but is not limited thereto. The provision unit may, for example, have the AI generate a message to notify the user based on the analysis result. The AI can generate a message to inform the user which areas should be brushed more thoroughly based on the analysis result. By gently informing the user of the unbrushed areas, the user can brush their teeth appropriately. Some or all of the above-described processing in the provision unit may be performed using AI or without using AI. For example, the provision unit may input the analysis result to the AI, and the AI may generate a notification message. Specifically, the provision unit receives, as input data, structured data such as the binary mask of unbrushed areas, score map, and labels for each tooth (e.g., “Upper right molar: 0.85” etc.) received from the analysis unit or specifying unit. The provision unit can input these data to a natural language generation model (for example, a Transformer-based large language model) and generate personalized text messages for the user, such as “The upper right molar has not been brushed yet” or “The lower left incisor is clean.” The provision unit can also input the generated text message to a speech synthesis module and notify the user as voice feedback. For example, output examples include “The probability of unbrushed area on the upper right molar is high, so please brush it again” or “Overall, your teeth are clean.” The provision unit can refer to the user's past tooth brushing history and emotion estimation results to dynamically adjust the notification content and expression method. For training the AI model, actual user feedback history and examples of guidance by dentists are used, and the weights are optimized using loss functions such as cross-entropy loss or BLEU score. Unlike conventional static notifications or simple rule-based message generation, the provision unit automatically generates natural language feedback optimized for each user, thereby improving user understanding and motivation. The technical effect is that the provision unit enables users to intuitively understand which areas should be brushed more thoroughly, contributing to the improvement of tooth brushing habits and maintenance of oral health. Application fields include home tooth brushing support apps, tooth brushing education for children, self-care guidance at dental clinics, and oral care support in nursing care settings.

The provision unit can display a praising message generated by AI when the user brushes properly. The provision unit uses AI to display a praising message when the user brushes properly. Praising messages may include, for example, the content of the message, display format, etc., but are not limited thereto. The provision unit may, for example, have the AI generate a praising message for the user based on the analysis result. The AI can generate a praising message when the user brushes properly. By displaying a praising message, the user's motivation can be increased. Some or all of the above-described processing in the provision unit may be performed using AI or without using AI. For example, the provision unit may input the analysis result to the AI, and the AI may generate a praising message. Specifically, the provision unit receives, as input data, the score map of unbrushed areas and labels for each tooth (e.g., “Upper right molar: 0.05” etc.) received from the analysis unit. The provision unit performs threshold judgment, such as determining that the probability of unbrushed areas for all teeth is below 0.2, and when the condition is met, generates praising messages such as “You brushed very well!” or “Perfect again today!” The provision unit uses a natural language generation model to refer to the user's past tooth brushing history and emotion estimation results, and can personalize the content and timing of praise. The provision unit can input the generated praising message to a speech synthesis module and notify the user by voice or text. For example, output examples include “The upper right molar is also clean. Excellent!” or “You have improved compared to yesterday!” For training the AI model, user motivation improvement history and examples of praise by dentists are used, and the weights are optimized using loss functions such as cross-entropy loss or emotion estimation accuracy. Unlike conventional static praise or simple rule-based judgment, the provision unit automatically generates praising messages optimized for each user, thereby contributing to the continuation of tooth brushing habits and improvement of motivation. The technical effect is that the provision unit promotes behavioral change in users and contributes to the maintenance of health and establishment of tooth brushing habits. Application fields include home tooth brushing support apps, tooth brushing education for children, self-care guidance at dental clinics, and oral care support in nursing care settings.

The acquisition unit can estimate the user's emotion and adjust the timing of acquiring the tooth brushing video based on the estimated emotion. The acquisition unit uses AI to estimate the user's emotion and adjust the timing of acquiring the tooth brushing video based on the estimated emotion. Emotion estimation may include, for example, facial expression recognition, voice analysis, etc., but is not limited thereto. The acquisition unit may, for example, have the AI analyze the user's facial expression and estimate the emotion. The AI can determine whether the user is relaxed or tense from the user's facial expression and adjust the timing of acquiring the tooth brushing video. By adjusting the acquisition timing based on the user's emotion, the video can be acquired at an appropriate timing. Some or all of the above-described processing in the acquisition unit may be performed using AI or without using AI. For example, the acquisition unit may input the user's facial expression data to the AI, and the AI may estimate the emotion and adjust the acquisition timing. Specifically, the acquisition unit receives the user's facial images or voice data obtained from a smartphone camera as input data. For facial images, RGB image tensors (e.g., shape 1, 224, 224, 3) or sequences of video frames (e.g., 3 seconds of video at 30 frames per second) are used as input, and for voice data, waveform data sampled at 16 kHz or MFCC feature vectors (e.g., shape 1, 100, 40) are used as input. The acquisition unit performs preprocessing such as face region detection, facial landmark extraction, voice noise removal, and spectrogram conversion on these data, and inputs the obtained features to emotion estimation models such as convolutional neural networks (CNN), recurrent neural networks (RNN), or Transformer-based multimodal emotion recognition models. The acquisition unit obtains, as output from the AI model, emotion labels (e.g., “Relaxed,” “Tense,” “Anxious,” etc.), emotion scores (e.g., Relaxed 0.75, Tense 0.15, Anxious 0.10), and time-series emotion change graphs. For example, output examples such as “Relaxed: 0.80,” “Tense: 0.10,” “Anxious: 0.10,” or “Tension increased in the last 10 seconds” can be obtained. The acquisition unit inputs these emotion estimation results to the video acquisition timing control module and implements dynamic acquisition timing control such as “Start video acquisition only when the user is relaxed,” “Pause acquisition when tension is high,” or “Acquire high-resolution video when emotion is stable.” For training the emotion estimation model, actual user facial and voice data and emotion annotation data are used, and the weights are optimized using loss functions such as cross-entropy loss or emotion estimation accuracy metrics. Unlike conventional simple timers or subjective human judgment for video acquisition, the acquisition unit combines AI-based high-dimensional feature extraction and multimodal analysis to automatically determine the optimal video acquisition timing according to the user's psychological state. The technical effect is that the acquisition unit can acquire tooth brushing video with high accuracy in a natural state while minimizing user stress and discomfort, greatly contributing to the improvement of subsequent AI analysis accuracy and user experience. Application fields include home tooth brushing support apps, tooth brushing education for children, self-care guidance at dental clinics, oral care support in nursing care settings, and remote medical acquisition of oral video with patient psychological state monitoring.

The acquisition unit can analyze the user's past tooth brushing history and select an appropriate acquisition method. The acquisition unit uses AI to analyze the user's past tooth brushing history and select an appropriate acquisition method. Tooth brushing history may include, for example, past tooth brushing data, recording methods, etc., but is not limited thereto. The acquisition unit may, for example, have the AI analyze the user's past tooth brushing data and select the optimal camera angle or shooting timing. The AI can focus on capturing areas where unbrushed areas were frequent in the user's past tooth brushing history. By analyzing past tooth brushing history, the optimal acquisition method can be selected. Some or all of the above-described processing in the acquisition unit may be performed using AI or without using AI. For example, the acquisition unit may input the user's past tooth brushing data to the AI, and the AI may select the optimal acquisition method. Specifically, the acquisition unit receives a database of tooth brushing history accumulated for each user (e.g., structured data including date, time, unbrushed area mask, unbrushed score for each tooth, shooting angle, shooting device information, etc.) as input data. The acquisition unit inputs these history data to time-series analysis models (e.g., LSTM, GRU, Transformer Encoder) or feature extraction algorithms (e.g., principal component analysis, clustering) to extract user-specific unbrushed area trends and shooting patterns. The acquisition unit obtains, as output from the AI model, pattern analysis results such as “High frequency of unbrushed areas on the upper right molar in the past 30 brushings,” “More unbrushed areas during nighttime shooting,” “Detection accuracy decreases when shooting at a specific angle,” and recommended acquisition parameters (e.g., camera angle θ=30 degrees, shooting timing=after breakfast, resolution=1080p). For example, output examples such as “Focus on close-up shooting of the upper right molar,” “Increase lighting for nighttime shooting,” “Shoot the lower left incisor as usual” can be obtained. The acquisition unit inputs these analysis results to the video acquisition control module and automatically sets camera angle, zoom ratio, lighting conditions, shooting timing, etc., optimized for each user and area. For training the history analysis model, actual user history data and indicators for improving unbrushed area detection accuracy are used, and the weights are optimized using regression loss or classification accuracy. Unlike conventional uniform shooting methods or angle selection based on human experience, the acquisition unit combines AI-based high-dimensional history analysis and personalized control to automatically determine the optimal video acquisition method for each user. The technical effect is that the acquisition unit contributes to improving unbrushed area detection accuracy, user experience, optimization of shooting efficiency, and homogenization of data quality. Application fields include home tooth brushing support apps, tooth brushing education for children, self-care guidance at dental clinics, oral care support in nursing care settings, and long-term oral health management systems.

The acquisition unit can perform filtering based on the health condition inside the user's mouth when acquiring the tooth brushing video. The acquisition unit uses AI to perform filtering based on the health condition inside the user's mouth when acquiring the tooth brushing video. Filtering may include, for example, filtering conditions, technologies used, etc., but is not limited thereto. The acquisition unit may, for example, have the AI analyze the health condition inside the user's mouth and perform filtering to acquire appropriate video. The AI can refrain from acquiring video if inflammation is present in the user's mouth. By performing filtering based on the health condition inside the mouth, appropriate video can be acquired. Some or all of the above-described processing in the acquisition unit may be performed using AI or without using AI. For example, the acquisition unit may input the user's oral health condition data to the AI, and the AI may perform filtering. Specifically, the acquisition unit receives intraoral image tensors obtained from a smartphone camera (e.g., shape 1, 720, 1280, 3), sequences of video frames, and the user's oral health history data (e.g., inflammation history, oral bleeding records, dentist diagnosis results, etc.) as input data. The acquisition unit performs preprocessing such as oral region segmentation, color tone analysis, and abnormal area detection on these data, and inputs the obtained features to health condition determination models such as convolutional neural networks (CNN) or anomaly detection models (e.g., AutoEncoder, One-Class SVM). The acquisition unit obtains, as output from the AI model, health condition labels (e.g., “Normal,” “Inflammation,” “Bleeding,” “Swelling”), abnormal area masks (e.g., shape 720, 1280, values are 0 or 1), and abnormality scores (e.g., 0.85). For example, output examples such as “Inflammation: 0.90,” “Normal: 0.10,” or “Abnormality detected in the lower right gingival area” can be obtained. The acquisition unit inputs these health condition determination results to the video acquisition filtering control module and implements dynamic acquisition control such as “Pause video acquisition when inflammation or bleeding is detected,” “Acquire high-resolution video only when no abnormal areas are present,” or “Prioritize notification to the dentist when abnormal areas are present.” For training the health condition determination model, actual oral images and abnormality annotation data by dentists are used, and the weights are optimized using loss functions such as cross-entropy loss or anomaly detection accuracy metrics. Unlike conventional human visual inspection or simple rule-based judgment, the acquisition unit combines AI-based high-dimensional feature extraction and anomaly detection algorithms to automatically realize optimal video acquisition filtering according to the user's health condition. The technical effect is that the acquisition unit contributes to reducing user health risks, suppressing unnecessary video acquisition, improving data quality, and streamlining medical collaboration. Application fields include home tooth brushing support apps, self-care guidance at dental clinics, oral care support in nursing care settings, and remote medical acquisition of video with health condition monitoring.

The acquisition unit can estimate the user's emotion and determine the priority of the video to be acquired based on the estimated emotion. The acquisition unit uses AI to estimate the user's emotion and determine the priority of the video to be acquired based on the estimated emotion. Emotion estimation may include, for example, facial expression recognition, voice analysis, etc., but is not limited thereto. The acquisition unit may, for example, have the AI analyze the user's facial expression and estimate the emotion. The AI can determine whether the user is relaxed or tense from the user's facial expression and determine the priority of the video to be acquired. By determining the priority of the video to be acquired based on the user's emotion, appropriate video can be acquired. Some or all of the above-described processing in the acquisition unit may be performed using AI or without using AI. For example, the acquisition unit may input the user's facial expression data to the AI, and the AI may estimate the emotion and determine the priority of the video to be acquired. Specifically, the acquisition unit receives facial image tensors obtained from a smartphone camera (e.g., shape 1, 224, 224, 3) or voice data (e.g., 16 kHz waveform, MFCC feature vector) as input data. The acquisition unit performs preprocessing such as face region detection, facial expression feature extraction, and voice spectrum analysis on these data, and inputs the obtained features to emotion estimation models such as convolutional neural networks (CNN), recurrent neural networks (RNN), or Transformer-based emotion recognition models. The acquisition unit obtains, as output from the AI model, emotion labels (e.g., “Relaxed,” “Tense,” “Anxious”), emotion scores (e.g., Relaxed 0.70, Tense 0.20, Anxious 0.10), and time-series emotion change graphs. For example, output examples such as “Relaxed: 0.80,” “Tense: 0.10,” “Anxious: 0.10,” or “Tension increased in the last 10 seconds” can be obtained. The acquisition unit inputs these emotion estimation results to the video acquisition priority determination module and implements dynamic priority control such as “Prioritize acquisition of overall video when the user is relaxed,” “Prioritize close-up video of the face when tension is high,” or “Pause acquisition when emotion is unstable.” For training the emotion estimation model, actual user facial and voice data and emotion annotation data are used, and the weights are optimized using loss functions such as cross-entropy loss or emotion estimation accuracy metrics. Unlike conventional uniform video acquisition or subjective human judgment for prioritization, the acquisition unit combines AI-based high-dimensional feature extraction and multimodal analysis to automatically determine the optimal video acquisition priority according to the user's psychological state. The technical effect is that the acquisition unit can efficiently acquire necessary video while minimizing user stress and discomfort, greatly contributing to the improvement of subsequent AI analysis accuracy and user experience. Application fields include home tooth brushing support apps, tooth brushing education for children, self-care guidance at dental clinics, oral care support in nursing care settings, and remote medical acquisition of oral video with patient psychological state monitoring.

The acquisition unit can preferentially acquire relevant videos based on the user's geographic location information when acquiring the tooth brushing video. The acquisition unit uses AI to preferentially acquire relevant videos based on the user's geographic location information when acquiring the tooth brushing video. Geographic location information may include, for example, GPS data, location information services, etc., but is not limited thereto. The acquisition unit may, for example, have the AI analyze the user's geographic location information and preferentially acquire relevant videos. The AI can acquire videos adapted to the climate or environment of the region where the user is located. By acquiring relevant videos based on geographic location information, appropriate videos can be acquired. Some or all of the above-described processing in the acquisition unit may be performed using AI or without using AI. For example, the acquisition unit may input the user's geographic location information data to the AI, and the AI may preferentially acquire relevant videos. Specifically, the acquisition unit receives latitude and longitude data (e.g., 35.6895, 139.6917), location history, climate information (e.g., temperature, humidity, weather), and a database of regional dental disease trends (e.g., regional caries incidence rate, fluoride concentration) obtained from the smartphone's GPS sensor or location information service as input data. The acquisition unit inputs these data to geographic information analysis models (e.g., geospatial clustering, geographic feature extraction algorithms) or multimodal AI models (e.g., location information+image information integration models) to estimate optimal video acquisition conditions for the user's current location and environment. The acquisition unit obtains, as output from the AI model, recommended acquisition parameters or priority shooting areas such as “High risk of oral mold due to high humidity in the current location,” “Focus on shooting the gingival area in cold regions due to increased risk of gingivitis,” or “In urban areas, shoot the oral mucosa in detail considering the impact of PM2.5.” For example, output examples such as “Focus on shooting the gingival area in Hokkaido,” “Shoot the surface of the teeth in high resolution in Okinawa” can be obtained. The acquisition unit inputs these analysis results to the video acquisition control module and automatically sets optimal camera angle, zoom ratio, lighting conditions, shooting timing, etc., according to the region, climate, and environment. For training the geographic information analysis model, actual location information data and dental disease trend data are used, and the weights are optimized using regression loss or classification accuracy. Unlike conventional uniform video acquisition or shooting condition setting based on human experience, the acquisition unit combines AI-based geographic feature extraction and personalized control to automatically determine the optimal video acquisition method for the user's current location and environment. The technical effect is that the acquisition unit realizes high-precision oral video acquisition considering region-specific risks and environmental factors, contributing to the prevention of dental diseases and efficiency of health management. Application fields include home tooth brushing support apps, region-specific dental health management, self-care guidance at dental clinics, oral care support in nursing care settings, and remote medical acquisition of oral video linked to geographic information.

The acquisition unit can analyze the user's social media activity and acquire related videos when acquiring the tooth brushing video. The acquisition unit uses AI to analyze the user's social media activity and acquire related videos when acquiring the tooth brushing video. Social media activity may include, for example, post content, activity frequency, etc., but is not limited thereto. The acquisition unit may, for example, have the AI analyze the user's social media activity and acquire related videos. The AI can refer to photos or videos of tooth brushing shared by the user on social media to acquire videos. By analyzing social media activity, related videos can be acquired. Some or all of the above-described processing in the acquisition unit may be performed using AI or without using AI. For example, the acquisition unit may input the user's social media activity data to the AI, and the AI may acquire related videos. Specifically, the acquisition unit receives post data obtained from the user's social media API (e.g., text, images, videos, post date and time, hashtags, number of comments, number of likes, etc.) and activity frequency data (e.g., number of posts per day, ratio of tooth brushing-related posts) as input data. The acquisition unit performs post content analysis using natural language processing (NLP) models (e.g., BERT, GPT-based models), tooth brushing image detection using image analysis models (e.g., CNN, Vision Transformer), and activity pattern extraction using time-series analysis. The acquisition unit obtains, as output from the AI model, behavioral trend analysis results such as “Increase in recent tooth brushing-related posts,” “Many images of unbrushed areas on the upper right molar,” “Many nighttime tooth brushing video posts,” and recommended acquisition parameters (e.g., acquire close-up video of specific areas, shoot in sync with posting timing). For example, output examples such as “Prioritize acquisition of close-up images of the upper right molar,” “Recommend video shooting at night” can be obtained. The acquisition unit inputs these analysis results to the video acquisition control module and automatically sets optimal camera angle, zoom ratio, shooting timing, etc., linked to the user's social media activity. For training the social media analysis model, actual post data and tooth brushing behavior data are used, and the weights are optimized using classification loss or behavior prediction accuracy. Unlike conventional uniform video acquisition or shooting condition setting based on subjective human judgment, the acquisition unit combines AI-based behavioral trend analysis and personalized control to automatically determine the optimal video acquisition method according to the user's social media activity. The technical effect is that the acquisition unit contributes to promoting behavioral change in users, visualizing tooth brushing habits, improving data quality, and streamlining SNS-linked health management. Application fields include home tooth brushing support apps, SNS-linked tooth brushing education, self-care guidance at dental clinics, oral care support in nursing care settings, and remote medical acquisition of oral video linked to behavioral analysis.

The analysis unit can estimate the user's emotion and adjust the method of presenting the analysis based on the estimated emotion. The analysis unit uses AI to estimate the user's emotion and adjust the method of presenting the analysis based on the estimated emotion. Emotion estimation may include, for example, facial expression recognition, voice analysis, etc., but is not limited thereto. The analysis unit may, for example, have the AI analyze the user's facial expression and estimate the emotion. The AI can determine whether the user is relaxed or tense from the user's facial expression and adjust the method of presenting the analysis result. By adjusting the method of presenting the analysis based on the user's emotion, appropriate analysis results can be provided. Some or all of the above-described processing in the analysis unit may be performed using AI or without using AI. For example, the analysis unit may input the user's facial expression data to the AI, and the AI may estimate the emotion and adjust the method of presenting the analysis result. Specifically, the analysis unit receives facial image tensors obtained from a smartphone camera (e.g., shape 1, 224, 224, 3), sequences of video frames (e.g., 3 seconds of video at 30 frames per second), and voice data (e.g., 16 kHz waveform, MFCC feature vector) as input data. The analysis unit performs preprocessing such as face region detection, facial expression feature extraction, voice spectrum analysis, noise removal, and spectrogram conversion on these data, and inputs the obtained features to emotion estimation models such as convolutional neural networks (CNN), recurrent neural networks (RNN), or Transformer-based multimodal emotion recognition models. The analysis unit obtains, as output from the AI model, emotion labels (e.g., “Relaxed,” “Tense,” “Anxious”), emotion scores (e.g., Relaxed 0.75, Tense 0.15, Anxious 0.10), and time-series emotion change graphs. For example, output examples such as “Relaxed: 0.80,” “Tense: 0.10,” “Anxious: 0.10,” or “Tension increased in the last 10 seconds” can be obtained. The analysis unit inputs these emotion estimation results to the analysis result presentation method control module and implements dynamic presentation method adjustment such as “Provide detailed analysis results in natural language when the user is relaxed,” “Switch to concise and gentle expressions when tension is high,” or “Prioritize positive feedback when anxiety is strong.” The analysis unit uses a natural language generation model (e.g., Transformer-based large language model) to generate the content, expression, and tone of the analysis result personalized according to the user's emotional state. For example, output examples include “There is a slight unbrushed area on the upper right molar, but overall the condition is very good” or “You seem tense, so let's continue brushing slowly for now.” For training the emotion estimation model and presentation adjustment model, actual user facial and voice data, emotion annotation, examples of guidance by dentists, and user reaction history are used, and the weights are optimized using loss functions such as cross-entropy loss, BLEU score, or emotion estimation accuracy metrics. Unlike conventional uniform analysis result display or expression adjustment based on subjective human judgment, the analysis unit combines AI-based high-dimensional feature extraction, multimodal analysis, and natural language generation to automatically determine the optimal method of presenting the analysis result according to the user's psychological state. The technical effect is that the analysis unit realizes presentation of analysis results that minimizes user stress and discomfort while enhancing understanding and satisfaction, thereby strengthening motivation for improving tooth brushing habits and maintaining health. Application fields include home tooth brushing support apps, tooth brushing education for children, self-care guidance at dental clinics, oral care support in nursing care settings, and remote medical presentation of oral analysis results linked to psychological state.

The analysis unit can adjust the level of detail of the analysis based on the health condition of the teeth during analysis. The analysis unit uses AI to adjust the level of detail of the analysis based on the health condition of the teeth during analysis. The level of detail of the analysis may include, for example, depth of analysis, number of analysis items, etc., but is not limited thereto. The analysis unit may, for example, have the AI analyze the health condition of the user's teeth and adjust the level of detail of the analysis. The AI can provide concise analysis results when the user's teeth are in good health. By adjusting the level of detail of the analysis based on the health condition of the teeth, appropriate analysis results can be provided. Some or all of the above-described processing in the analysis unit may be performed using AI or without using AI. For example, the analysis unit may input the user's dental health condition data to the AI, and the AI may adjust the level of detail of the analysis. Specifically, the analysis unit receives intraoral image tensors obtained from a smartphone camera (e.g., shape 1, 720, 1280, 3), sequences of video frames, and the user's dental checkup history or oral health score (e.g., dentist diagnosis results, past unbrushed area scores, inflammation/bleeding history, etc.) as input data. The analysis unit performs preprocessing such as oral region segmentation, color tone analysis, and abnormal area detection on these data, and inputs the obtained features to health condition determination models such as convolutional neural networks (CNN) or anomaly detection models (e.g., AutoEncoder, One-Class SVM). The analysis unit obtains, as output from the AI model, health condition labels (e.g., “Normal,” “Inflammation,” “Bleeding,” “Swelling”), abnormal area masks (e.g., shape 720, 1280, values are 0 or 1), and abnormality scores (e.g., 0.85). For example, output examples such as “Normal: 0.90,” “Inflammation: 0.10,” or “Abnormality detected in the lower right gingival area” can be obtained. The analysis unit inputs these health condition determination results to the analysis detail level control module and implements dynamic detail level adjustment such as “Provide concise analysis of only major items when health condition is good,” “Conduct detailed area-specific analysis and additional item analysis when abnormality is high,” or “Provide detailed cause estimation and countermeasure proposals when inflammation or bleeding is detected.” The analysis unit uses natural language generation models or report generation algorithms to generate the content, number of items, and depth of explanation of the analysis result personalized according to the health condition. For example, output examples include “Overall, your oral health is good. No particular problems were found” or “Mild inflammation was observed on the lower right molar. Detailed care methods are described below.” For training the health condition determination model and detail level control model, actual oral images, health history data, examples of diagnosis by dentists, and user reaction history are used, and the weights are optimized using loss functions such as cross-entropy loss, anomaly detection accuracy metrics, or BLEU score. Unlike conventional uniform analysis detail level or item selection based on human experience, the analysis unit combines AI-based high-dimensional feature extraction and health condition-linked control to automatically determine the optimal analysis detail level for each user and condition. The technical effect is that the analysis unit can prevent user burden and information overload while providing detailed analysis quickly and accurately when necessary, thereby contributing to the improvement of tooth brushing habits, maintenance of health, and efficiency of medical collaboration. Application fields include home tooth brushing support apps, self-care guidance at dental clinics, oral care support in nursing care settings, and remote medical generation of health condition-linked analysis reports.

The analysis unit can apply different analysis algorithms according to the category of the teeth during analysis. The analysis unit uses AI to apply different analysis algorithms according to the category of the teeth during analysis. Categories of teeth may include, for example, incisors, molars, canines, etc., but are not limited thereto. The analysis unit may, for example, have the AI apply different analysis algorithms for incisors and molars. The AI can select and apply appropriate analysis algorithms according to the characteristics of incisors and molars. By applying different analysis algorithms according to the category of the teeth, appropriate analysis results can be provided. Some or all of the above-described processing in the analysis unit may be performed using AI or without using AI. For example, the analysis unit may input tooth category data to the AI, and the AI may apply appropriate analysis algorithms. Specifically, the analysis unit receives intraoral image tensors obtained from a smartphone camera (e.g., shape 1, 720, 1280, 3) or sequences of video frames as input data. The analysis unit uses tooth region segmentation models (e.g., U-Net, Mask R-CNN) to automatically label each tooth category (incisor, molar, canine, etc.). The analysis unit selects different image analysis algorithms or AI models for each category (e.g., CNN for incisors, Vision Transformer for molars, ResNet for canines) and executes optimal feature extraction and analysis processing for each tooth region. For example, the analysis unit emphasizes edge detection and surface stain analysis for incisors, applies groove and hidden unbrushed area detection algorithms for molars, and strengthens boundary analysis with the gums for canines, constructing a category-specific analysis pipeline. The analysis unit obtains, as output from the AI model, category-specific unbrushed area masks, score maps, and abnormality detection labels. For example, output examples include “Incisor: surface stain detection 0.15,” “Molar: occlusal surface unbrushed area 0.80,” “Canine: gum boundary abnormality 0.05.” The analysis unit integrates these category-specific analysis results and utilizes them for generating optimized analysis reports and feedback for each user and area. For training the category-specific model, actual dental image data and area-specific annotation by dentists are used, and the weights are optimized using loss functions such as cross-entropy loss, Dice loss, or area-specific detection accuracy metrics. Unlike conventional uniform image analysis or area determination based on human experience, the analysis unit combines AI-based high-dimensional feature extraction and category-specific algorithm selection to automatically realize high-precision analysis adapted to the structural and functional diversity of teeth. The technical effect is that the analysis unit contributes to improving detection accuracy of unbrushed areas and abnormalities for each area, optimizing analysis speed, and generating personalized feedback for each user. Application fields include home tooth brushing support apps, area-specific self-care guidance at dental clinics, oral care support in nursing care settings, and remote medical area-specific oral analysis.

The analysis unit can estimate the user's emotion and adjust the length of the analysis based on the estimated emotion. The analysis unit uses AI to estimate the user's emotion and adjust the length of the analysis based on the estimated emotion. Emotion estimation may include, for example, facial expression recognition, voice analysis, etc., but is not limited thereto. The analysis unit may, for example, have the AI analyze the user's facial expression and estimate the emotion. The AI can determine whether the user is relaxed or tense from the user's facial expression and adjust the length of the analysis. By adjusting the length of the analysis based on the user's emotion, appropriate analysis results can be provided. Some or all of the above-described processing in the analysis unit may be performed using AI or without using AI. For example, the analysis unit may input the user's facial expression data to the AI, and the AI may estimate the emotion and adjust the length of the analysis. Specifically, the analysis unit receives facial image tensors obtained from a smartphone camera (e.g., shape 1, 224, 224, 3) or voice data (e.g., 16 kHz waveform, MFCC feature vector) as input data. The analysis unit performs preprocessing such as face region detection, facial expression feature extraction, and voice spectrum analysis on these data, and inputs the obtained features to emotion estimation models such as convolutional neural networks (CNN), recurrent neural networks (RNN), or Transformer-based emotion recognition models. The analysis unit obtains, as output from the AI model, emotion labels (e.g., “Relaxed,” “Tense,” “Anxious”), emotion scores (e.g., Relaxed 0.70, Tense 0.20, Anxious 0.10), and time-series emotion change graphs. For example, output examples such as “Relaxed: 0.85,” “Tense: 0.10,” “Anxious: 0.05,” or “Tension increased in the last 10 seconds” can be obtained. The analysis unit inputs these emotion estimation results to the analysis result generation module and implements dynamic length adjustment such as “Provide detailed analysis results in long text when the user is relaxed,” “Present only key points in concise short text when tension is high,” or “Prioritize positive content and shorten when anxiety is strong.” The analysis unit uses a natural language generation model (e.g., Transformer-based large language model) to generate the amount of text, depth of explanation, and tone of the analysis result personalized according to the user's emotional state. For example, output examples include “There is a slight unbrushed area on the upper right molar. Details are as follows . . . ” or “Overall, your teeth are clean. Keep up the good work.” For training the emotion estimation model and length control model, actual user facial and voice data, emotion annotation, examples of guidance by dentists, and user reaction history are used, and the weights are optimized using loss functions such as cross-entropy loss, BLEU score, or emotion estimation accuracy metrics. Unlike conventional uniform analysis result display or text length adjustment based on subjective human judgment, the analysis unit combines AI-based high-dimensional feature extraction, multimodal analysis, and natural language generation to automatically determine the optimal length of the analysis result according to the user's psychological state. The technical effect is that the analysis unit realizes presentation of analysis results that minimizes user stress and discomfort while enhancing understanding and satisfaction, thereby strengthening motivation for improving tooth brushing habits and maintaining health. Application fields include home tooth brushing support apps, tooth brushing education for children, self-care guidance at dental clinics, oral care support in nursing care settings, and remote medical presentation of oral analysis results linked to psychological state.

The analysis unit can determine the priority of analysis based on the frequency of tooth brushing during analysis. The analysis unit uses AI to determine the priority of analysis based on the frequency of tooth brushing during analysis. The frequency of tooth brushing may include, for example, the number of times per day or per week, but is not limited to such examples. For instance, the analysis unit may input the user's tooth brushing frequency data to AI, which analyzes the data and determines the priority. The AI can prioritize the analysis of areas that the user brushes frequently. By determining the priority of analysis based on the frequency of tooth brushing, appropriate analysis results can be provided. Some or all of the above-described processing in the analysis unit may be performed using AI or without using AI. For example, the analysis unit may input the user's tooth brushing frequency data to AI, which then determines the priority. Specifically, the analysis unit receives as input data a tooth brushing history database accumulated for each user (e.g., structured data including date, time, unbrushed area mask, unbrushed score for each tooth, brushing frequency, shooting angle, shooting device information, etc.). The analysis unit inputs these history data into a time-series analysis model (e.g., LSTM, GRU, Transformer Encoder) or feature extraction algorithm (e.g., principal component analysis, clustering, etc.) to extract trends in unbrushed areas and patterns of tooth brushing frequency for each user. The analysis unit obtains, as output from the AI model, pattern analysis results such as “high frequency of unbrushed areas in the upper right molars over the past 30 brushings,” “lower left incisors have few unbrushed areas each time,” “low frequency of nighttime brushing,” and an analysis priority list (e.g., upper right molars→lower left incisors→lower right molars, etc.). For example, output examples include “analyze the upper right molars with the highest priority” and “analyze the lower left incisors as usual.” The analysis unit inputs these analysis results into an analysis control module to automatically set the optimal analysis order and focus areas for each user and each site. In training the history analysis model, the analysis unit uses actual user history data and indicators for improving unbrushed area detection accuracy, optimizing the model using regression loss or classification accuracy as the loss function. Unlike conventional uniform analysis order or site selection based on human heuristics, the analysis unit combines high-dimensional history analysis by AI and personalized control to automatically determine the optimal analysis priority for each user. The technical effects of the analysis unit include contributing to improved unbrushed area detection accuracy, enhanced user experience, optimized analysis efficiency, and homogenization of data quality. Application fields include home tooth brushing support apps, tooth brushing education for children, self-care guidance at dental clinics, oral care support in nursing care settings, and long-term oral health management systems.

The analysis unit can adjust the order of analysis based on the relevance of the teeth during analysis. The analysis unit uses AI to adjust the order of analysis based on the relevance of the teeth during analysis. The relevance of the teeth may include, for example, adjacent teeth or teeth in the same category, but is not limited to such examples. For instance, the analysis unit may use AI to analyze in order from the incisors to the molars. The AI can perform analysis in an appropriate order based on the relevance of the teeth. By adjusting the order of analysis based on the relevance of the teeth, appropriate analysis results can be provided. Some or all of the above-described processing in the analysis unit may be performed using AI or without using AI. For example, the analysis unit may input tooth relevance data to AI, which then adjusts the order of analysis. Specifically, the analysis unit receives as input data oral image tensors (e.g., shape 1, 720, 1280, 3) or continuous video frame sequences acquired from a smartphone camera. The analysis unit uses a tooth region segmentation model (e.g., U-Net, Mask R-CNN) to automatically label the position, category, and adjacency of each tooth. The analysis unit constructs a tooth relevance graph (e.g., nodes=teeth, edges=adjacency or category match) and uses a graph neural network (GNN) or relevance score calculation algorithm to optimize the analysis order. The analysis unit automatically generates rules such as “incisors→canines→premolars→molars,” “continuously analyze adjacent teeth with high frequency of unbrushed areas,” or “analyze teeth in the same category together,” and reflects these in the analysis pipeline. The analysis unit obtains, as output from the AI model, an analysis order list (e.g., by tooth number, by category, by relevance score) and a list of sites with analysis priority. For example, output examples include “incisors→upper right molars→lower left incisors” or “continuously analyze upper right and lower right molars.” The analysis unit inputs these analysis orders into an analysis control module to automatically set the optimal analysis order for each user and each site. In training the relevance graph model, the analysis unit uses actual dental image data, examples of analysis order by dentists, and indicators for improving unbrushed area detection accuracy, optimizing the model using graph structure loss or classification accuracy as the loss function. Unlike conventional uniform analysis order or site selection based on human heuristics, the analysis unit combines high-dimensional relevance analysis by AI and graph structure optimization to automatically realize high-precision analysis order determination based on the structural and functional relevance of the teeth. The technical effects of the analysis unit include contributing to improved analysis efficiency, improved unbrushed area detection accuracy, and generation of personalized analysis order for each user. Application fields include home tooth brushing support apps, site-specific self-care guidance at dental clinics, oral care support in nursing care settings, and relevance-optimized oral analysis in telemedicine.

The provision unit can estimate the user's emotion and adjust the method of presenting provision based on the estimated emotion. The provision unit uses AI to estimate the user's emotion and adjust the method of presenting provision based on the estimated emotion. Emotion estimation may include, for example, facial expression recognition or voice analysis, but is not limited to such examples. For instance, the provision unit may use AI to analyze the user's facial expression and estimate emotion. The AI can determine whether the user is relaxed or tense from the facial expression and adjust the method of presenting provision accordingly. By adjusting the method of presenting provision based on the user's emotion, appropriate feedback can be provided. Some or all of the above-described processing in the provision unit may be performed using AI or without using AI. For example, the provision unit may input the user's facial expression data to AI, which then estimates emotion and adjusts the method of presenting provision. Specifically, the provision unit receives as input data face image tensors (e.g., shape 1, 224, 224, 3) or continuous video frame sequences (e.g., 30 frames/sec for 3 seconds), and audio data (e.g., 16 kHz waveform, MFCC feature vector) acquired from a smartphone camera. The provision unit performs preprocessing such as face region detection, facial expression feature extraction, audio spectrum analysis, noise removal, and spectrogram conversion on these data, and inputs the obtained features into a convolutional neural network (CNN), recurrent neural network (RNN), or Transformer-based multimodal emotion recognition model for emotion estimation. The provision unit obtains, as output from the AI model, emotion labels (e.g., “relaxed,” “tense,” “anxious”), emotion scores (e.g., relaxed 0.75, tense 0.15, anxious 0.10), and time-series emotion change graphs. For example, output examples include “relaxed: 0.80,” “tense: 0.10,” “anxious: 0.10,” or “tension increased in the last 10 seconds.” The provision unit inputs these emotion estimation results into a provision expression control module to dynamically adjust the method of presenting provision, such as “if the user is relaxed, provide a detailed explanation of the analysis results in natural language,” “if tension is high, switch to concise and gentle expressions,” or “if anxiety is strong, prioritize positive feedback.” The provision unit can use a natural language generation model (e.g., Transformer-based large language model) to generate personalized content, expression, and tone of analysis results according to the user's emotional state. For example, output examples include “There is a slight unbrushed area on the upper right molar, but overall the condition is very good,” or “You seem tense, so let's continue brushing slowly for now.” In training the emotion estimation model and expression adjustment model, the provision unit uses actual user facial expression and audio data, emotion annotations, examples of guidance by dentists, and user reaction history, optimizing weights using cross-entropy loss, BLEU score, emotion estimation accuracy indicators, etc. Unlike conventional uniform display of analysis results or subjective adjustment of expression by humans, the provision unit combines high-dimensional feature extraction by AI, multimodal analysis, and natural language generation to automatically determine the optimal method of presenting analysis results according to the user's psychological state. The technical effects of the provision unit include minimizing user stress and discomfort, improving understanding and satisfaction, and strengthening motivation for improving tooth brushing habits and maintaining health. Application fields include home tooth brushing support apps, tooth brushing education for children, self-care guidance at dental clinics, oral care support in nursing care settings, and psychological state-linked oral analysis result presentation in telemedicine.

The provision unit can adjust the level of detail of provision based on the importance of the analysis result during provision. The provision unit uses AI to adjust the level of detail of provision based on the importance of the analysis result during provision. The level of detail of provision may include, for example, the depth of content provided or the number of items provided, but is not limited to such examples. For instance, the provision unit may use AI to evaluate the importance of the analysis result and adjust the level of detail of provision. The AI can provide important analysis results in detail. By adjusting the level of detail of provision based on the importance of the analysis result, appropriate feedback can be provided. Some or all of the above-described processing in the provision unit may be performed using AI or without using AI. For example, the provision unit may input analysis result importance data to AI, which then adjusts the level of detail of provision. Specifically, the provision unit receives as input data structured data such as binary masks of unbrushed areas, score maps, and labels for each tooth (e.g., “upper right molar: 0.85”) received from the analysis unit or specifying unit, as well as importance scores for each analysis item (e.g., continuous values from 0.0 to 1.0 or category labels such as “high,” “medium,” “low”). The provision unit inputs these data into an importance evaluation model (e.g., LightGBM, random forest decision tree models, or Transformer-based importance estimation models) to automatically determine the priority and level of detail for each analysis item. The provision unit obtains, as output from the AI model, detail control parameters (e.g., number of detailed explanation items=5, number of simple explanation items=2, detail score=0.8) and a list of explanation depths for each item. For example, output examples include “provide a detailed explanation for the unbrushed area on the upper right molar,” “provide a simple explanation for the lower left incisor,” and “provide only the main points for the overall evaluation.” The provision unit inputs these detail control results into a natural language generation model or report generation algorithm to generate personalized feedback, providing important analysis results in detail and less important items concisely. In training the detail control model, the provision unit uses actual user feedback history, examples of guidance by dentists, and user reaction data, optimizing weights using cross-entropy loss, BLEU score, importance estimation accuracy indicators, etc. Unlike conventional uniform explanations or adjustment of detail level based on human heuristics, the provision unit combines high-dimensional feature extraction by AI and importance-linked control to automatically determine the optimal explanation depth for each user and situation. The technical effects of the provision unit include preventing user burden and information overload, and providing detailed analysis explanations quickly and accurately when necessary, thereby contributing to improved tooth brushing habits, health maintenance, and efficiency in medical collaboration. Application fields include home tooth brushing support apps, self-care guidance at dental clinics, oral care support in nursing care settings, and importance-linked analysis report generation in telemedicine.

The provision unit can apply different provision algorithms according to the category of the analysis result during provision. The provision unit uses AI to apply different provision algorithms according to the category of the analysis result during provision. Provision algorithms may include, for example, recommendation algorithms or personalized algorithms, but are not limited to such examples. For instance, the provision unit may use AI to evaluate the category of the analysis result and apply an appropriate provision algorithm. The AI can provide detailed feedback for unbrushed areas. By applying different provision algorithms according to the category of the analysis result, appropriate feedback can be provided. Some or all of the above-described processing in the provision unit may be performed using AI or without using AI. For example, the provision unit may input analysis result category data to AI, which then applies an appropriate provision algorithm. Specifically, the provision unit receives as input data category labels of analysis results (e.g., “unbrushed area,” “stain,” “inflammation,” “normal”), site information (e.g., incisor, molar, canine), and user attribute data (e.g., age, tooth brushing history, emotional state) received from the analysis unit or specifying unit. The provision unit inputs these data into a category determination model (e.g., LightGBM, SVM, Transformer Encoder) or recommendation algorithm (e.g., collaborative filtering, personalized ranking model) to automatically select the optimal provision algorithm for each category. The provision unit obtains, as output from the AI model, category-specific provision algorithm selection results (e.g., “unbrushed area→detailed explanation+image emphasis,” “stain→care method recommendation,” “inflammation→recommendation to visit a medical institution,” “normal→simple feedback”) and personalized provision parameters. For example, output examples include “provide a detailed image explanation for the unbrushed area on the upper right molar,” “recommend care methods for the stain on the lower left incisor,” and “provide a medical collaboration message for gingival inflammation.” The provision unit inputs these algorithm selection results into a natural language generation model or image generation module to generate optimized feedback or advice for each category. In training the category-specific algorithm, the provision unit uses actual dental image data, user history, and examples of guidance by dentists, optimizing weights using cross-entropy loss or recommendation accuracy indicators. Unlike conventional uniform explanations or category determination based on human heuristics, the provision unit combines high-dimensional feature extraction by AI and category-specific algorithm selection to automatically realize high-precision feedback corresponding to the diversity of analysis results. The technical effects of the provision unit include improved detection accuracy for unbrushed areas and abnormalities by site, optimized analysis speed, and generation of personalized feedback for each user. Application fields include home tooth brushing support apps, site-specific self-care guidance at dental clinics, oral care support in nursing care settings, and category-specialized oral analysis in telemedicine.

The provision unit can estimate the user's emotion and adjust the length of provision based on the estimated emotion. The provision unit uses AI to estimate the user's emotion and adjust the length of provision based on the estimated emotion. Emotion estimation may include, for example, facial expression recognition or voice analysis, but is not limited to such examples. For instance, the provision unit may use AI to analyze the user's facial expression and estimate emotion. The AI can determine whether the user is relaxed or tense from the facial expression and adjust the length of provision accordingly. By adjusting the length of provision based on the user's emotion, appropriate feedback can be provided. Some or all of the above-described processing in the provision unit may be performed using AI or without using AI. For example, the provision unit may input the user's facial expression data to AI, which then estimates emotion and adjusts the length of provision. Specifically, the provision unit receives as input data face image tensors (e.g., shape 1, 224, 224, 3) and audio data (e.g., 16 kHz waveform, MFCC feature vector) acquired from a smartphone camera. The provision unit performs preprocessing such as face region detection, facial expression feature extraction, and audio spectrum analysis on these data, and inputs the obtained features into a convolutional neural network (CNN), recurrent neural network (RNN), or Transformer-based emotion recognition model for emotion estimation. The provision unit obtains, as output from the AI model, emotion labels (e.g., “relaxed,” “tense,” “anxious”), emotion scores (e.g., relaxed 0.70, tense 0.20, anxious 0.10), and time-series emotion change graphs. For example, output examples include “relaxed: 0.85,” “tense: 0.10,” “anxious: 0.05,” or “tension increased in the last 10 seconds.” The provision unit inputs these emotion estimation results into a provision result generation module to dynamically adjust the length of provision, such as “if the user is relaxed, provide detailed feedback in a long text,” “if tension is high, present only the main points concisely in a short text,” or “if anxiety is strong, prioritize positive content and shorten.” The provision unit can use a natural language generation model (e.g., Transformer-based large language model) to generate personalized feedback volume, explanation depth, and tone according to the user's emotional state. For example, output examples include “There is a slight unbrushed area on the upper right molar. Details are as follows . . . ” or “Overall, your teeth are well brushed. Keep up the good work.” In training the emotion estimation model and length control model, the provision unit uses actual user facial expression and audio data, emotion annotations, examples of guidance by dentists, and user reaction history, optimizing weights using cross-entropy loss, BLEU score, emotion estimation accuracy indicators, etc. Unlike conventional uniform feedback display or subjective adjustment of text volume by humans, the provision unit combines high-dimensional feature extraction by AI, multimodal analysis, and natural language generation to automatically determine the optimal feedback length according to the user's psychological state. The technical effects of the provision unit include minimizing user stress and discomfort, improving understanding and satisfaction, and strengthening motivation for improving tooth brushing habits and maintaining health. Application fields include home tooth brushing support apps, tooth brushing education for children, self-care guidance at dental clinics, oral care support in nursing care settings, and psychological state-linked oral analysis result presentation in telemedicine.

The provision unit can determine the priority of provision based on the submission timing of the analysis result during provision. The provision unit uses AI to determine the priority of provision based on the submission timing of the analysis result during provision. Submission timing may include, for example, submission date or submission time, but is not limited to such examples. For instance, the provision unit may use AI to evaluate the submission timing of the analysis result and determine the priority of provision. The AI can prioritize the provision of the most recent analysis results. By determining the priority of provision based on the submission timing of the analysis result, appropriate feedback can be provided. Some or all of the above-described processing in the provision unit may be performed using AI or without using AI. For example, the provision unit may input analysis result submission timing data to AI, which then determines the priority of provision. Specifically, the provision unit receives as input data analysis result submission time data (e.g., timestamp, date, time, elapsed time) and the user's tooth brushing history database (e.g., list of past analysis results, history of unbrushed area scores) received from the analysis unit or specifying unit. The provision unit inputs these data into a time-series analysis model (e.g., LSTM, GRU, Transformer Encoder) or priority determination algorithm (e.g., FIFO, LRU, importance-weighted priority determination model) to automatically determine the optimal provision order based on submission timing. The provision unit obtains, as output from the AI model, a provision priority list (e.g., latest analysis result→past analysis result→reference result from history) and a list of provision items with priority. For example, output examples include “provide the analysis result from this morning with the highest priority” and “display last night's result as reference information in a simplified manner.” The provision unit inputs these priority determination results into a user interface or notification module to prioritize the most timely and important analysis results for the user. In training the priority determination model, the provision unit uses actual user history data, user reaction history, and examples of guidance by dentists, optimizing weights using regression loss, classification accuracy, user satisfaction indicators, etc. Unlike conventional uniform provision order or time-series management based on human heuristics, the provision unit combines high-dimensional history analysis by AI and time-series optimization to automatically determine the optimal provision priority for each user and situation. The technical effects of the provision unit include improved efficiency and satisfaction in information acquisition by users, maintenance of freshness of analysis results, and efficiency in medical collaboration. Application fields include home tooth brushing support apps, self-care guidance at dental clinics, oral care support in nursing care settings, and time-series-linked analysis result presentation in telemedicine.

The provision unit can adjust the order of provision based on the relevance of the analysis result during provision. The provision unit uses AI to adjust the order of provision based on the relevance of the analysis result during provision. The order of provision may include, for example, order by importance or order by relevance, but is not limited to such examples. For instance, the provision unit may use AI to evaluate the relevance of the analysis result and adjust the order of provision. The AI can prioritize the provision of unbrushed areas. By adjusting the order of provision based on the relevance of the analysis result, appropriate feedback can be provided. Some or all of the above-described processing in the provision unit may be performed using AI or without using AI. For example, the provision unit may input analysis result relevance data to AI, which then adjusts the order of provision. Specifically, the provision unit receives as input data relevance scores of analysis results (e.g., continuous values from 0.0 to 1.0 or category labels such as “high,” “medium,” “low”), site information (e.g., tooth number, category, adjacency), and the user's tooth brushing history database (e.g., past frequency of unbrushed areas, focus areas) received from the analysis unit or specifying unit. The provision unit inputs these data into a relevance evaluation model (e.g., graph neural network, clustering algorithm, Transformer Encoder) or order optimization algorithm (e.g., relevance score-based sorting, importance-weighted order determination model) to automatically determine the optimal order of provision based on relevance. The provision unit obtains, as output from the AI model, a provision order list (e.g., unbrushed areas→abnormal areas→normal areas) and a list of provision items with priority. For example, output examples include “provide the unbrushed area on the upper right molar with the highest priority,” “provide the stain on the lower left incisor next,” and “display the overall evaluation last in a simplified manner.” The provision unit inputs these order determination results into a user interface or notification module to prioritize the most important and relevant analysis results for the user. In training the relevance evaluation model, the provision unit uses actual user history data, examples of guidance by dentists, and user reaction history, optimizing weights using graph structure loss, classification accuracy, user satisfaction indicators, etc. Unlike conventional uniform provision order or relevance determination based on human heuristics, the provision unit combines high-dimensional relevance analysis by AI and order optimization to automatically determine the optimal order of provision for each user and situation. The technical effects of the provision unit include improved efficiency and satisfaction in information acquisition by users, reflection of importance in analysis results, and efficiency in medical collaboration. Application fields include home tooth brushing support apps, self-care guidance at dental clinics, oral care support in nursing care settings, and relevance-optimized analysis result presentation in telemedicine.

The specifying unit can estimate the user's emotion and adjust the method of identifying unbrushed areas based on the estimated emotion. The specifying unit uses AI to estimate the user's emotion and adjust the method of identifying unbrushed areas based on the estimated emotion. Emotion estimation may include, for example, facial expression recognition or voice analysis, but is not limited to such examples. For instance, the specifying unit may use AI to analyze the user's facial expression and estimate emotion. The AI can determine whether the user is relaxed or tense from the facial expression and adjust the method of identifying unbrushed areas accordingly. By adjusting the method of identifying unbrushed areas based on the user's emotion, appropriate identification of unbrushed areas can be achieved. Some or all of the above-described processing in the specifying unit may be performed using AI or without using AI. For example, the specifying unit may input the user's facial expression data to AI, which then estimates emotion and adjusts the method of identifying unbrushed areas. Specifically, the specifying unit receives as input data face image tensors (e.g., shape 1, 224, 224, 3), continuous video frame sequences (e.g., 30 frames/sec for 3 seconds), and audio data (e.g., 16 kHz waveform, MFCC feature vector) acquired from a smartphone camera. The specifying unit performs preprocessing such as face region detection, facial expression feature extraction, audio spectrum analysis, noise removal, and spectrogram conversion on these data, and inputs the obtained features into a convolutional neural network (CNN), recurrent neural network (RNN), or Transformer-based multimodal emotion recognition model for emotion estimation. The specifying unit obtains, as output from the AI model, emotion labels (e.g., “relaxed,” “tense,” “anxious”), emotion scores (e.g., relaxed 0.75, tense 0.15, anxious 0.10), and time-series emotion change graphs. For example, output examples include “relaxed: 0.80,” “tense: 0.10,” “anxious: 0.10,” or “tension increased in the last 10 seconds.” The specifying unit inputs these emotion estimation results into an unbrushed area identification algorithm selection module to dynamically adjust the method of identification, such as “if the user is relaxed, apply a detailed image analysis algorithm,” “if tension is high, apply a simple and fast identification algorithm,” or “if anxiety is strong, tighten the threshold to reduce the risk of false detection.” In training the unbrushed area identification model, the specifying unit uses actual user facial expression and audio data, emotion annotations, examples of identification by dentists, and user reaction history, optimizing weights using cross-entropy loss, emotion estimation accuracy indicators, and unbrushed area detection accuracy. Unlike conventional uniform identification algorithms or subjective adjustment of identification methods by humans, the specifying unit combines high-dimensional feature extraction by AI, multimodal analysis, and emotion-linked algorithm selection to automatically determine the optimal method of identifying unbrushed areas according to the user's psychological state. The technical effects of the specifying unit include minimizing user stress and discomfort, optimizing unbrushed area detection accuracy and analysis speed, and strengthening motivation for user experience and health maintenance. Application fields include home tooth brushing support apps, tooth brushing education for children, self-care guidance at dental clinics, oral care support in nursing care settings, and psychological state-linked oral analysis in telemedicine.

The specifying unit can improve the accuracy of identification based on the health condition of the teeth when identifying unbrushed areas. The specifying unit uses AI to improve the accuracy of identification based on the health condition of the teeth when identifying unbrushed areas. Accuracy of identification may include, for example, analysis accuracy or detection accuracy, but is not limited to such examples. For instance, the specifying unit may use AI to analyze the user's dental health condition and improve the accuracy of identification. The AI can perform simple identification of unbrushed areas when the user's dental health condition is good. By improving the accuracy of identification based on the health condition of the teeth, appropriate identification of unbrushed areas can be achieved. Some or all of the above-described processing in the specifying unit may be performed using AI or without using AI. For example, the specifying unit may input the user's dental health condition data to AI, which then improves the accuracy of identification. Specifically, the specifying unit receives as input data oral image tensors (e.g., shape 1, 720, 1280, 3), continuous video frame sequences, and the user's dental checkup history or oral health score (e.g., dentist's diagnosis results, past unbrushed area scores, inflammation/bleeding history, etc.) acquired from a smartphone camera. The specifying unit performs preprocessing such as oral region segmentation, color tone analysis, and abnormal site detection on these data, and inputs the obtained features into a convolutional neural network (CNN) for health condition determination or an anomaly detection model (e.g., AutoEncoder, One-Class SVM). The specifying unit obtains, as output from the AI model, health condition labels (e.g., “normal,” “inflammation,” “bleeding,” “swelling”), abnormal site masks (e.g., shape 720, 1280, values 0 or 1), and abnormality scores (e.g., 0.85). For example, output examples include “normal: 0.90,” “inflammation: 0.10,” or “abnormality detected in the lower right gingival area.” The specifying unit inputs these health condition determination results into an unbrushed area identification accuracy control module to dynamically adjust the accuracy, such as “if health condition is good, perform simple identification for major sites only,” “if abnormality is high, perform detailed site-specific identification and additional item identification,” or “if inflammation or bleeding is detected, provide detailed cause estimation and countermeasure proposals.” The specifying unit can use a natural language generation model or report generation algorithm to generate personalized content, number of items, and explanation depth of identification results according to health condition. In training the health condition determination model and accuracy control model, the specifying unit uses actual oral images, health history data, examples of diagnosis by dentists, and user reaction history, optimizing weights using cross-entropy loss, anomaly detection accuracy indicators, BLEU score, etc. Unlike conventional uniform identification accuracy or item selection based on human heuristics, the specifying unit combines high-dimensional feature extraction by AI and health condition-linked control to automatically determine the optimal identification accuracy for each user and condition. The technical effects of the specifying unit include preventing user burden and information overload, and providing detailed identification quickly and accurately when necessary, thereby contributing to improved tooth brushing habits, health maintenance, and efficiency in medical collaboration. Application fields include home tooth brushing support apps, self-care guidance at dental clinics, oral care support in nursing care settings, and health condition-linked identification report generation in telemedicine.

The specifying unit can estimate the user's emotion and determine the priority of identification based on the estimated emotion. The specifying unit uses AI to estimate the user's emotion and determine the priority of identification based on the estimated emotion. Emotion estimation may include, for example, facial expression recognition or voice analysis, but is not limited to such examples. For instance, the specifying unit may use AI to analyze the user's facial expression and estimate emotion. The AI can determine whether the user is relaxed or tense from the facial expression and determine the priority of identification accordingly. By determining the priority of identification based on the user's emotion, appropriate identification of unbrushed areas can be achieved. Some or all of the above-described processing in the specifying unit may be performed using AI or without using AI. For example, the specifying unit may input the user's facial expression data to AI, which then estimates emotion and determines the priority of identification. Specifically, the specifying unit receives as input data face image tensors (e.g., shape 1, 224, 224, 3) and audio data (e.g., 16 kHz waveform, MFCC feature vector) acquired from a smartphone camera. The specifying unit performs preprocessing such as face region detection, facial expression feature extraction, and audio spectrum analysis on these data, and inputs the obtained features into a convolutional neural network (CNN), recurrent neural network (RNN), or Transformer-based emotion recognition model for emotion estimation. The specifying unit obtains, as output from the AI model, emotion labels (e.g., “relaxed,” “tense,” “anxious”), emotion scores (e.g., relaxed 0.70, tense 0.20, anxious 0.10), and time-series emotion change graphs. For example, output examples include “relaxed: 0.85,” “tense: 0.10,” “anxious: 0.05,” or “tension increased in the last 10 seconds.” The specifying unit inputs these emotion estimation results into an unbrushed area identification priority determination module to dynamically control the priority, such as “if the user is relaxed, prioritize overall identification of unbrushed areas,” “if tension is high, prioritize sites the user is concerned about,” or “if anxiety is strong, postpone sites with high risk of false detection.” In training the emotion estimation model, the specifying unit uses actual user facial expression and audio data and emotion annotation data, optimizing weights using cross-entropy loss and emotion estimation accuracy indicators. Unlike conventional uniform identification order or subjective prioritization by humans, the specifying unit combines high-dimensional feature extraction by AI and multimodal analysis to automatically determine the optimal priority of identification of unbrushed areas according to the user's psychological state. The technical effects of the specifying unit include minimizing user stress and discomfort and efficiently performing necessary identification of unbrushed areas, thereby greatly contributing to subsequent AI analysis accuracy and improvement of user experience. Application fields include home tooth brushing support apps, tooth brushing education for children, self-care guidance at dental clinics, oral care support in nursing care settings, and psychological state-linked oral analysis in telemedicine.

The specifying unit can apply different identification algorithms according to the category of the teeth when identifying unbrushed areas. The specifying unit uses AI to apply different identification algorithms according to the category of the teeth when identifying unbrushed areas. Identification algorithms may include, for example, image analysis algorithms or the use of AI technology, but are not limited to such examples. For instance, the specifying unit may use AI to apply different identification algorithms for incisors and molars. The AI can select appropriate identification algorithms according to the characteristics of incisors and molars and perform identification of unbrushed areas. By applying different identification algorithms according to the category of the teeth, appropriate identification of unbrushed areas can be achieved. Some or all of the above-described processing in the specifying unit may be performed using AI or without using AI. For example, the specifying unit may input tooth category data to AI, which then applies an appropriate identification algorithm. Specifically, the specifying unit receives as input data oral image tensors (e.g., shape 1, 720, 1280, 3) or continuous video frame sequences acquired from a smartphone camera. The specifying unit uses a tooth region segmentation model (e.g., U-Net, Mask R-CNN) to automatically label the category of each tooth (incisor, molar, canine, etc.). The specifying unit selects different image analysis algorithms or AI models for each category (e.g., CNN for incisors, Vision Transformer for molars, ResNet for canines) and performs optimal feature extraction and analysis processing for each tooth region. For example, for incisors, the specifying unit emphasizes edge detection and surface stain analysis; for molars, applies groove and hidden unbrushed area detection algorithms for occlusal surfaces; and for canines, strengthens analysis of the boundary with the gums, thus constructing a category-specific identification pipeline. The specifying unit obtains, as output from the AI model, category-specific unbrushed area masks, score maps, and abnormality detection labels. For example, output examples include “incisor: surface stain detection 0.15,” “molar: occlusal surface unbrushed area 0.80,” “canine: gum boundary abnormality 0.05.” The specifying unit integrates these category-specific identification results and uses them to generate optimized identification reports or feedback for each user and site. In training the category-specific model, the specifying unit uses actual dental image data and site-specific annotations by dentists, optimizing weights using cross-entropy loss, Dice loss, and site-specific detection accuracy indicators. Unlike conventional uniform image analysis or site determination based on human heuristics, the specifying unit combines high-dimensional feature extraction by AI and category-specific algorithm selection to automatically realize high-precision identification of unbrushed areas corresponding to the structural and functional diversity of the teeth. The technical effects of the specifying unit include improved detection accuracy for unbrushed areas and abnormalities by site, optimized analysis speed, and generation of personalized feedback for each user. Application fields include home tooth brushing support apps, site-specific self-care guidance at dental clinics, oral care support in nursing care settings, and site-specialized oral analysis in telemedicine.

The feedback unit can estimate the user's emotion and adjust the method of presenting feedback based on the estimated emotion. The feedback unit uses AI to estimate the user's emotion and adjust the method of presenting feedback based on the estimated emotion. Emotion estimation may include, for example, facial expression recognition or voice analysis, but is not limited to such examples. For instance, the feedback unit may use AI to analyze the user's facial expression and estimate emotion. The AI can determine whether the user is relaxed or tense from the facial expression and adjust the method of presenting feedback accordingly. By adjusting the method of presenting feedback based on the user's emotion, appropriate feedback can be provided. Some or all of the above-described processing in the feedback unit may be performed using AI or without using AI. For example, the feedback unit may input the user's facial expression data to AI, which then estimates emotion and adjusts the method of presenting feedback. Specifically, the feedback unit receives as input data face image tensors (e.g., shape 1, 224, 224, 3), continuous video frame sequences (e.g., 30 frames/sec for 3 seconds), and audio data (e.g., 16 kHz waveform, MFCC feature vector) acquired from a smartphone camera. The feedback unit performs preprocessing such as face region detection, facial expression feature extraction, audio spectrum analysis, noise removal, and spectrogram conversion on these data, and inputs the obtained features into a convolutional neural network (CNN), recurrent neural network (RNN), or Transformer-based multimodal emotion recognition model for emotion estimation. The feedback unit obtains, as output from the AI model, emotion labels (e.g., “relaxed,” “tense,” “anxious”), emotion scores (e.g., relaxed 0.80, tense 0.10, anxious 0.10), and time-series emotion change graphs. For example, output examples include “relaxed: 0.85,” “tense: 0.10,” “anxious: 0.05,” or “tension increased in the last 10 seconds.” The feedback unit inputs these emotion estimation results into a feedback expression control module to dynamically adjust the method of presenting feedback, such as “if the user is relaxed, provide a detailed explanation of the analysis results in natural language,” “if tension is high, switch to concise and gentle expressions,” or “if anxiety is strong, prioritize positive feedback.” The feedback unit can use a natural language generation model (e.g., Transformer-based large language model) to generate personalized content, expression, and tone of analysis results according to the user's emotional state. For example, output examples include “There is a slight unbrushed area on the upper right molar, but overall the condition is very good,” or “You seem tense, so let's continue brushing slowly for now.” In training the emotion estimation model and expression adjustment model, the feedback unit uses actual user facial expression and audio data, emotion annotations, examples of guidance by dentists, and user reaction history, optimizing weights using cross-entropy loss, BLEU score, emotion estimation accuracy indicators, etc. Unlike conventional uniform display of analysis results or subjective adjustment of expression by humans, the feedback unit combines high-dimensional feature extraction by AI, multimodal analysis, and natural language generation to automatically determine the optimal method of presenting feedback according to the user's psychological state. The technical effects of the feedback unit include minimizing user stress and discomfort, improving understanding and satisfaction, and strengthening motivation for improving tooth brushing habits and maintaining health. Application fields include home tooth brushing support apps, tooth brushing education for children, self-care guidance at dental clinics, oral care support in nursing care settings, and psychological state-linked oral analysis result presentation in telemedicine.

The feedback unit can adjust the level of detail of feedback based on the importance of the analysis result during feedback. The feedback unit uses AI to adjust the level of detail of feedback based on the importance of the analysis result during feedback. The level of detail of feedback may include, for example, the depth of feedback content or the number of feedback items, but is not limited to such examples. For instance, the feedback unit may use AI to evaluate the importance of the analysis result and adjust the level of detail of feedback. The AI can provide important analysis results in detail in the feedback. By adjusting the level of detail of feedback based on the importance of the analysis result, appropriate feedback can be provided. Some or all of the above-described processing in the feedback unit may be performed using AI or without using AI. For example, the feedback unit may input analysis result importance data to AI, which then adjusts the level of detail of feedback. Specifically, the feedback unit receives as input data structured data such as binary masks of unbrushed areas, score maps, and labels for each tooth (e.g., “upper right molar: 0.85”) received from the analysis unit or specifying unit, as well as importance scores for each analysis item (e.g., continuous values from 0.0 to 1.0 or category labels such as “high,” “medium,” “low”). The feedback unit inputs these data into an importance evaluation model (e.g., LightGBM, random forest decision tree models, or Transformer-based importance estimation models) to automatically determine the priority and level of detail for each analysis item. The feedback unit obtains, as output from the AI model, detail control parameters (e.g., number of detailed explanation items=5, number of simple explanation items=2, detail score=0.8) and a list of explanation depths for each item. For example, output examples include “provide a detailed explanation for the unbrushed area on the upper right molar,” “provide a simple explanation for the lower left incisor,” and “provide only the main points for the overall evaluation.” The feedback unit inputs these detail control results into a natural language generation model or report generation algorithm to generate personalized feedback, providing important analysis results in detail and less important items concisely. In training the detail control model, the feedback unit uses actual user feedback history, examples of guidance by dentists, and user reaction data, optimizing weights using cross-entropy loss, BLEU score, importance estimation accuracy indicators, etc. Unlike conventional uniform explanations or adjustment of detail level based on human heuristics, the feedback unit combines high-dimensional feature extraction by AI and importance-linked control to automatically determine the optimal explanation depth for each user and situation. The technical effects of the feedback unit include preventing user burden and information overload, and providing detailed analysis explanations quickly and accurately when necessary, thereby contributing to improved tooth brushing habits, health maintenance, and efficiency in medical collaboration. Application fields include home tooth brushing support apps, self-care guidance at dental clinics, oral care support in nursing care settings, and importance-linked analysis report generation in telemedicine.

The feedback unit can estimate the user's emotion and adjust the length of feedback based on the estimated emotion. The feedback unit uses AI to estimate the user's emotion and adjust the length of feedback based on the estimated emotion. Emotion estimation may include, for example, facial expression recognition or voice analysis, but is not limited to such examples. For instance, the feedback unit may use AI to analyze the user's facial expression and estimate emotion. The AI can determine whether the user is relaxed or tense from the facial expression and adjust the length of feedback accordingly. By adjusting the length of feedback based on the user's emotion, appropriate feedback can be provided. Some or all of the above-described processing in the feedback unit may be performed using AI or without using AI. For example, the feedback unit may input the user's facial expression data to AI, which then estimates emotion and adjusts the length of feedback. Specifically, the feedback unit receives as input data face image tensors (e.g., shape 1, 224, 224, 3) and audio data (e.g., 16 kHz waveform, MFCC feature vector) acquired from a smartphone camera. The feedback unit performs preprocessing such as face region detection, facial expression feature extraction, and audio spectrum analysis on these data, and inputs the obtained features into a convolutional neural network (CNN), recurrent neural network (RNN), or Transformer-based emotion recognition model for emotion estimation. The feedback unit obtains, as output from the AI model, emotion labels (e.g., “relaxed,” “tense,” “anxious”), emotion scores (e.g., relaxed 0.70, tense 0.20, anxious 0.10), and time-series emotion change graphs. For example, output examples include “relaxed: 0.85,” “tense: 0.10,” “anxious: 0.05,” or “tension increased in the last 10 seconds.” The feedback unit inputs these emotion estimation results into a feedback generation module to dynamically adjust the length of feedback, such as “if the user is relaxed, provide detailed feedback in a long text,” “if tension is high, present only the main points concisely in a short text,” or “if anxiety is strong, prioritize positive content and shorten.” The feedback unit can use a natural language generation model (e.g., Transformer-based large language model) to generate personalized feedback volume, explanation depth, and tone according to the user's emotional state. For example, output examples include “There is a slight unbrushed area on the upper right molar. Details are as follows . . . ” or “Overall, your teeth are well brushed. Keep up the good work.” In training the emotion estimation model and length control model, the feedback unit uses actual user facial expression and audio data, emotion annotations, examples of guidance by dentists, and user reaction history, optimizing weights using cross-entropy loss, BLEU score, emotion estimation accuracy indicators, etc. Unlike conventional uniform feedback display or subjective adjustment of text volume by humans, the feedback unit combines high-dimensional feature extraction by AI, multimodal analysis, and natural language generation to automatically determine the optimal feedback length according to the user's psychological state. The technical effects of the feedback unit include minimizing user stress and discomfort, improving understanding and satisfaction, and strengthening motivation for improving tooth brushing habits and maintaining health. Application fields include home tooth brushing support apps, tooth brushing education for children, self-care guidance at dental clinics, oral care support in nursing care settings, and psychological state-linked oral analysis result presentation in telemedicine.

The feedback unit can determine the priority of feedback based on the submission timing of the analysis result during feedback. The feedback unit uses AI to determine the priority of feedback based on the submission timing of the analysis result during feedback. Submission timing may include, for example, submission date or submission time, but is not limited to such examples. For instance, the feedback unit may use AI to evaluate the submission timing of the analysis result and determine the priority of feedback. The AI can prioritize feedback for the most recent analysis results. By determining the priority of feedback based on the submission timing of the analysis result, appropriate feedback can be provided. Some or all of the above-described processing in the feedback unit may be performed using AI or without using AI. For example, the feedback unit may input analysis result submission timing data to AI, which then determines the priority of feedback. Specifically, the feedback unit receives as input data analysis result submission time data (e.g., timestamp, date, time, elapsed time) and the user's tooth brushing history database (e.g., list of past analysis results, history of unbrushed area scores) received from the analysis unit or specifying unit. The feedback unit inputs these data into a time-series analysis model (e.g., LSTM, GRU, Transformer Encoder) or priority determination algorithm (e.g., FIFO, LRU, importance-weighted priority determination model) to automatically determine the optimal feedback order based on submission timing. The feedback unit obtains, as output from the AI model, a feedback priority list (e.g., latest analysis result→past analysis result→reference result from history) and a list of feedback items with priority. For example, output examples include “provide feedback for the analysis result from this morning with the highest priority” and “display last night's result as reference information in a simplified manner.” The feedback unit inputs these priority determination results into a user interface or notification module to prioritize the most timely and important analysis results for the user. In training the priority determination model, the feedback unit uses actual user history data, user reaction history, and examples of guidance by dentists, optimizing weights using regression loss, classification accuracy, user satisfaction indicators, etc. Unlike conventional uniform feedback order or time-series management based on human heuristics, the feedback unit combines high-dimensional history analysis by AI and time-series optimization to automatically determine the optimal feedback priority for each user and situation. The technical effects of the feedback unit include improved efficiency and satisfaction in information acquisition by users, maintenance of freshness of analysis results, and efficiency in medical collaboration. Application fields include home tooth brushing support apps, self-care guidance at dental clinics, oral care support in nursing care settings, and time-series-linked analysis result presentation in telemedicine.

The praising unit can estimate the user's emotion and adjust the method of praising based on the estimated emotion. The praising unit uses AI to estimate the user's emotion and adjust the method of praising based on the estimated emotion. Emotion estimation may include, for example, facial expression recognition or voice analysis, but is not limited to such examples. For instance, the praising unit may use AI to analyze the user's facial expression and estimate emotion. The AI can determine whether the user is relaxed or tense from the facial expression and adjust the method of praising accordingly. By adjusting the method of praising based on the user's emotion, appropriate words of praise can be provided. Some or all of the above-described processing in the praising unit may be performed using AI or without using AI. For example, the praising unit may input the user's facial expression data to AI, which then estimates emotion and adjusts the method of praising.

The praising unit can refer to the user's past tooth brushing history when praising to select an appropriate method of praising. The praising unit uses AI to refer to the user's past tooth brushing history when praising to select an appropriate method of praising. Methods of praising may include, for example, the content of praise or the timing of praise, but are not limited to such examples. For instance, the praising unit may use AI to analyze the user's past tooth brushing data and select an appropriate method of praising. The AI can especially praise the user when they have properly brushed areas that previously had many unbrushed spots. By referring to past tooth brushing history, appropriate words of praise can be provided. Some or all of the above-described processing in the praising unit may be performed using AI or without using AI. For example, the praising unit may input the user's past tooth brushing data to AI, which then selects an appropriate method of praising.

The praising unit can estimate the user's emotion and adjust the frequency of praising based on the estimated emotion. The praising unit uses AI to estimate the user's emotion and adjust the frequency of praising based on the estimated emotion. Emotion estimation may include, for example, facial expression recognition or voice analysis, but is not limited to such examples. For instance, the praising unit may use AI to analyze the user's facial expression and estimate emotion. The AI can determine whether the user is relaxed or tense from the facial expression and adjust the frequency of praising accordingly. By adjusting the frequency of praising based on the user's emotion, appropriate words of praise can be provided. Some or all of the above-described processing in the praising unit may be performed using AI or without using AI. For example, the praising unit may input the user's facial expression data to AI, which then estimates emotion and adjusts the frequency of praising.

The praising unit can select an appropriate method of praising based on the user's geographic location information when praising. The praising unit uses AI to select an appropriate method of praising based on the user's geographic location information when praising. Geographic location information may include, for example, GPS data or location information services, but is not limited to such examples. For instance, the praising unit may use AI to analyze the user's geographic location information and select an appropriate method of praising. The AI can select a method of praising that matches the culture of the region where the user is located. By providing appropriate words of praise based on geographic location information, appropriate words of praise can be provided. Some or all of the above-described processing in the praising unit may be performed using AI or without using AI. For example, the praising unit may input the user's geographic location information data to AI, which then selects an appropriate method of praising.

The system according to the embodiment is not limited to the examples described above, and various modifications are possible, for example, as follows.

The tooth brushing support system may further include a reminder unit configured to record the user's tooth brushing habits and provide periodic reminders. The reminder unit analyzes the user's tooth brushing habits and sends reminders at appropriate times. For example, if the user has a habit of brushing their teeth in the morning and at night, the reminder unit can send reminders at specific times in the morning and at night. In addition, if the user tends to forget to brush their teeth, the reminder unit can send notifications to the user's smartphone to prompt tooth brushing. This makes it easier for the user to maintain their tooth brushing habits. Furthermore, the reminder unit may also provide advice to adjust the frequency and duration of tooth brushing based on the user's tooth brushing habits. For example, if the user's tooth brushing time is short, the reminder unit can advise the user to brush for a longer period.

The tooth brushing support system may further include a progress display unit configured to visualize the user's tooth brushing progress. The progress display unit displays the user's tooth brushing progress in real time. For example, when the user starts brushing their teeth, the progress display unit can show the progress of tooth brushing in graphs or charts. In addition, the progress display unit can display which areas have been brushed by color-coding them. This allows the user to visually check their tooth brushing progress. Furthermore, the progress display unit may also provide appropriate advice according to the user's tooth brushing progress. For example, if the user has forgotten to brush a specific area, the progress display unit can advise the user to focus on brushing that area.

The tooth brushing support system may further include an evaluation unit configured to evaluate the quality of the user's tooth brushing. The evaluation unit analyzes the quality of the user's tooth brushing and provides evaluation results. For example, after the user has brushed their teeth, the evaluation unit can analyze the remaining dirt or stains on the surface of the teeth and display the evaluation results. In addition, the evaluation unit may provide advice on improvements based on the quality of the user's tooth brushing. For example, if the user has left unbrushed areas, the evaluation unit can advise the user to focus on brushing those areas. Furthermore, the evaluation unit may continuously monitor the quality of the user's tooth brushing and provide evaluation results periodically. This enables the user to improve the quality of their tooth brushing.

The tooth brushing support system may also introduce game elements to increase the user's motivation for tooth brushing. For example, the user can earn points each time they brush their teeth and use those points to customize their avatar. In addition, when the user achieves certain goals, they can earn badges or trophies. This allows the user to enjoy tooth brushing. Furthermore, the tooth brushing support system may include a function that allows users to compete with each other. For example, users can share their tooth brushing progress with friends or family and compete in rankings. This increases the user's motivation for tooth brushing.

The tooth brushing support system may also store the user's tooth brushing data in the cloud and allow access from multiple devices. For example, the user can record tooth brushing data on their smartphone and store the data in the cloud. This enables the user to access their tooth brushing data from a home computer or tablet. In addition, the data stored in the cloud can be shared with the user's dentist. This allows the dentist to understand the user's tooth brushing status and provide appropriate advice. Furthermore, the data stored in the cloud can be analyzed to identify trends in the user's tooth brushing and propose long-term improvements. For example, if the user tends to leave certain areas unbrushed, advice can be provided to focus on brushing those areas based on the cloud data.

The tooth brushing support system may further include a plan creation unit configured to create an individualized tooth brushing plan based on the user's tooth brushing data. The plan creation unit analyzes the user's tooth brushing data and proposes an optimal tooth brushing plan. For example, an individualized tooth brushing plan can be created based on the user's tooth brushing frequency, duration, and tendency to leave unbrushed areas. In addition, the plan creation unit may adjust the tooth brushing plan according to the user's dental health condition. For example, if the user has many stains on their teeth, the plan creation unit can propose a tooth brushing method effective for stain removal. Furthermore, the plan creation unit may monitor the progress of the user's tooth brushing plan and update the plan as necessary. This enables the user to practice the optimal tooth brushing plan for themselves.

The tooth brushing support system may further include an evaluation unit configured to evaluate the effectiveness of tooth brushing based on the user's tooth brushing data. The evaluation unit analyzes the user's tooth brushing data and evaluates the effectiveness of tooth brushing. For example, after the user has brushed their teeth, the evaluation unit can analyze the degree of reduction of dirt or stains on the surface of the teeth and display the evaluation results. In addition, the evaluation unit may provide advice on improvements based on the effectiveness of the user's tooth brushing. For example, if the user has left unbrushed areas, the evaluation unit can advise the user to focus on brushing those areas. Furthermore, the evaluation unit may continuously monitor the effectiveness of the user's tooth brushing and provide evaluation results periodically. This enables the user to improve the effectiveness of their tooth brushing.

The tooth brushing support system may further include a training unit configured to provide a training program to improve the quality of tooth brushing based on the user's tooth brushing data. The training unit analyzes the user's tooth brushing data and proposes an optimal training program. For example, an individualized training program can be created based on the user's tooth brushing frequency, duration, and tendency to leave unbrushed areas. In addition, the training unit may adjust the training program according to the user's dental health condition. For example, if the user has many stains on their teeth, the training unit can propose a training program effective for stain removal. Furthermore, the training unit may monitor the progress of the user's training program and update the program as necessary. This enables the user to practice the optimal training program for themselves.

The tooth brushing support system may further include an advice unit configured to provide advice to improve the quality of tooth brushing based on the user's tooth brushing data. The advice unit analyzes the user's tooth brushing data and provides optimal advice. For example, individualized advice can be provided based on the user's tooth brushing frequency, duration, and tendency to leave unbrushed areas. In addition, the advice unit may adjust the advice according to the user's dental health condition. For example, if the user has many stains on their teeth, the advice unit can provide advice effective for stain removal. Furthermore, the advice unit may monitor the user's tooth brushing progress and update the advice as necessary. This enables the user to receive optimal advice for themselves.

The tooth brushing support system may further include a feedback unit configured to provide feedback to improve the quality of tooth brushing based on the user's tooth brushing data. The feedback unit analyzes the user's tooth brushing data and provides optimal feedback. For example, individualized feedback can be provided based on the user's tooth brushing frequency, duration, and tendency to leave unbrushed areas. In addition, the feedback unit may adjust the feedback according to the user's dental health condition. For example, if the user has many stains on their teeth, the feedback unit can provide feedback effective for stain removal. Furthermore, the feedback unit may monitor the user's tooth brushing progress and update the feedback as necessary. This enables the user to receive optimal feedback for themselves.

The following is a brief description of the processing flow of Example of the Embodiment.

Step 1: The acquisition unit acquires a video of the user's tooth brushing. The user's tooth brushing video may include videos, still images, or real-time footage. The acquisition unit captures the inside of the user's mouth using a smartphone camera. The smartphone camera may be a front camera, rear camera, or have various resolutions. Step 2: The analysis unit analyzes the video acquired by the acquisition unit. The analysis unit uses AI to analyze the condition of the user's teeth from the video and identify unbrushed areas. The analysis may include the use of image analysis algorithms and AI technologies. Step 3: The provision unit provides the analysis result obtained by the analysis unit to the user. The provision unit gently informs the user of the identified unbrushed areas. The provision may include notification methods and display formats, and may use voice feedback or text feedback. The provision unit may also input the analysis result to AI, and the AI may generate a message to notify the user based on the analysis result.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned acquisition unit, analysis unit, provision unit, specifying unit, feedback unit, and praising unit is implemented by at least one of, for example, the smart device 14 and the data processing apparatus 12. For example, the acquisition unit captures the inside of the user's mouth using the camera of the smart device 14. The analysis unit is implemented by a specific processing unit 290 of the data processing apparatus 12 and analyzes the acquired video. The provision unit, as a processing unit for notifying the user of the analysis result, is implemented by a control unit 46A of the smart device 14. The specifying unit is implemented by the specific processing unit 290 of the data processing apparatus 12 and identifies unbrushed areas. The feedback unit is implemented by the control unit 46A of the smart device 14 and provides feedback to the user. The praising unit is implemented by the specific processing unit 290 of the data processing apparatus 12 and generates a message to praise the user. The correspondence between each unit and the device or control unit is not limited to the examples described above and various modifications are possible.

### Second Embodiment

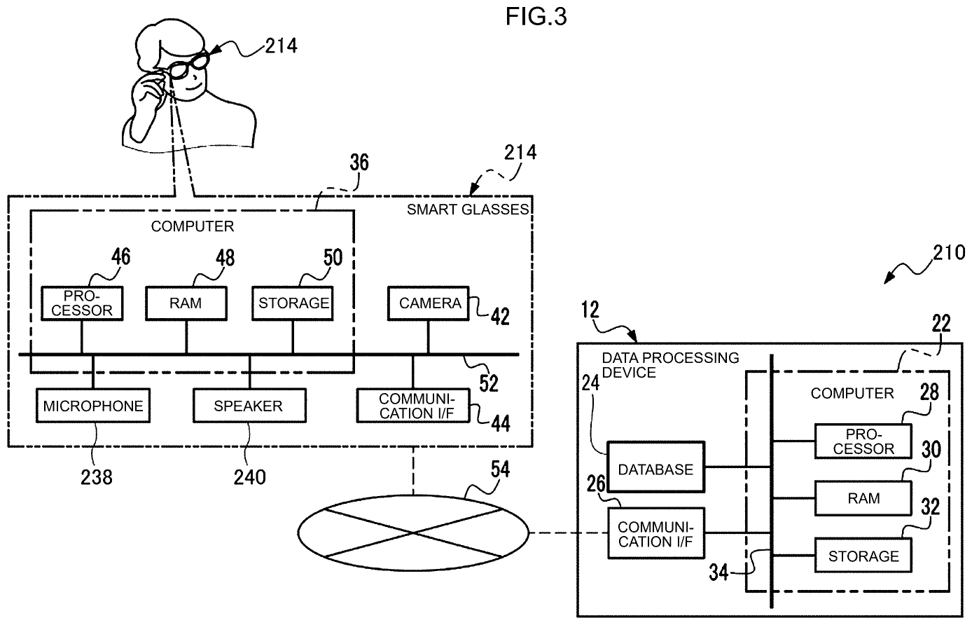

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

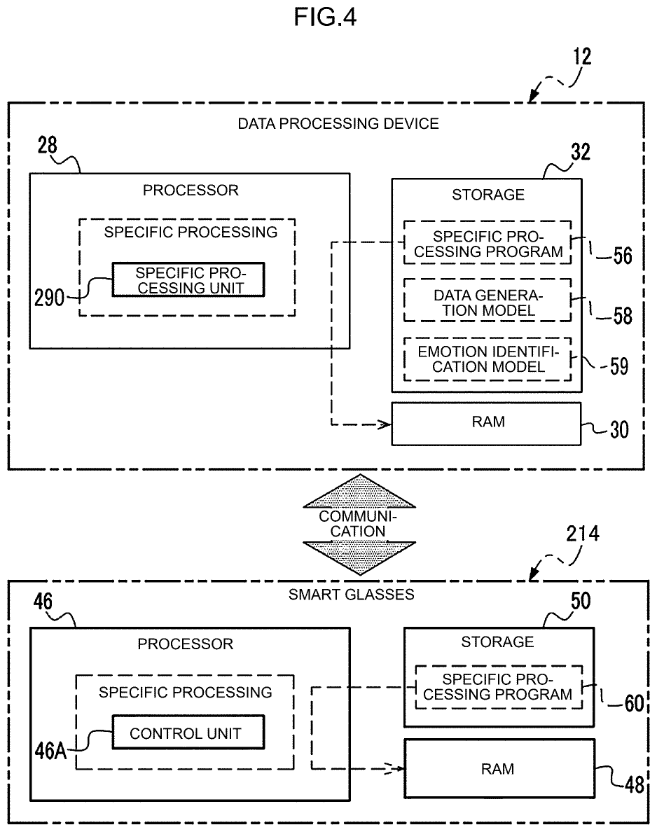

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned acquisition unit, analysis unit, provision unit, specifying unit, feedback unit, and praising unit is implemented by at least one of, for example, the smart glasses 214 and the data processing apparatus 12. For example, the acquisition unit captures the inside of the user's mouth using the camera of the smart glasses 214. The analysis unit is implemented by a specific processing unit 290 of the data processing apparatus 12 and analyzes the acquired video. The provision unit, as a processing unit for notifying the user of the analysis result, is implemented by a control unit 46A of the smart glasses 214. The specifying unit is implemented by the specific processing unit 290 of the data processing apparatus 12 and identifies unbrushed areas. The feedback unit is implemented by the control unit 46A of the smart glasses 214 and provides feedback to the user. The praising unit is implemented by the specific processing unit 290 of the data processing apparatus 12 and generates a message to praise the user. The correspondence between each unit and the device or control unit is not limited to the examples described above and various modifications are possible.

### Third Embodiment

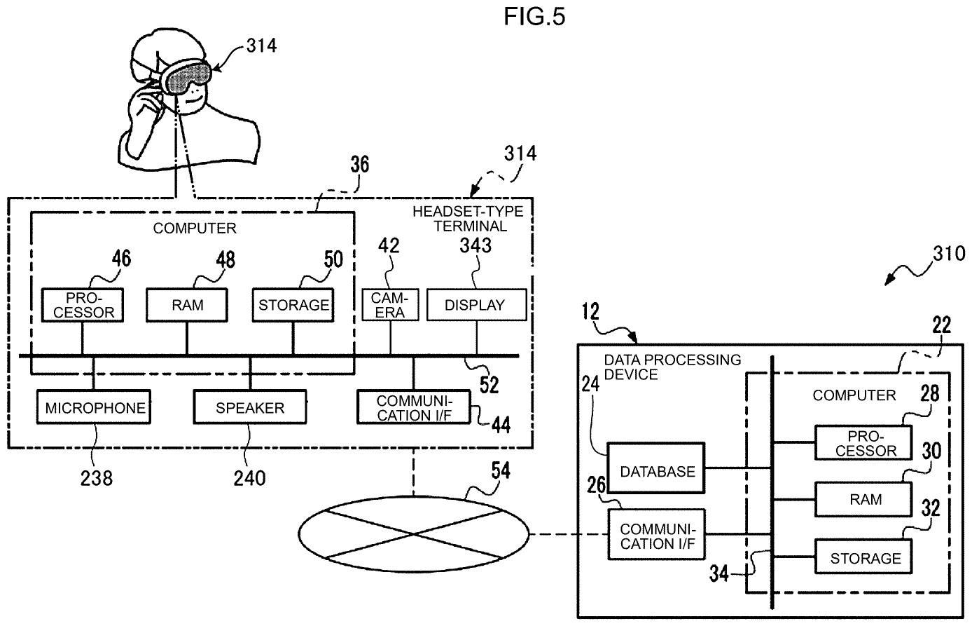

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

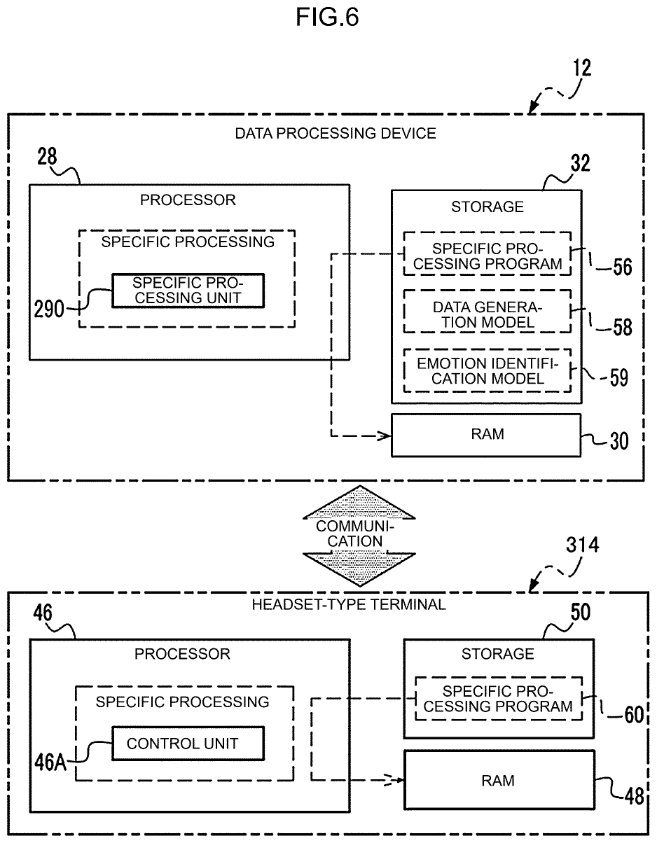

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned acquisition unit, analysis unit, provision unit, specifying unit, feedback unit, and praising unit is implemented by at least one of, for example, the headset-type terminal 314 and the data processing apparatus 12. For example, the acquisition unit captures the inside of the user's mouth using the camera of the headset-type terminal 314. The analysis unit is implemented by a specific processing unit 290 of the data processing apparatus 12 and analyzes the acquired video. The provision unit, as a processing unit for notifying the user of the analysis result, is implemented by a control unit 46A of the headset-type terminal 314. The specifying unit is implemented by the specific processing unit 290 of the data processing apparatus 12 and identifies unbrushed areas. The feedback unit is implemented by the control unit 46A of the headset-type terminal 314 and provides feedback to the user. The praising unit is implemented by the specific processing unit 290 of the data processing apparatus 12 and generates a message to praise the user. The correspondence between each unit and the device or control unit is not limited to the examples described above and various modifications are possible.

### Fourth Embodiment

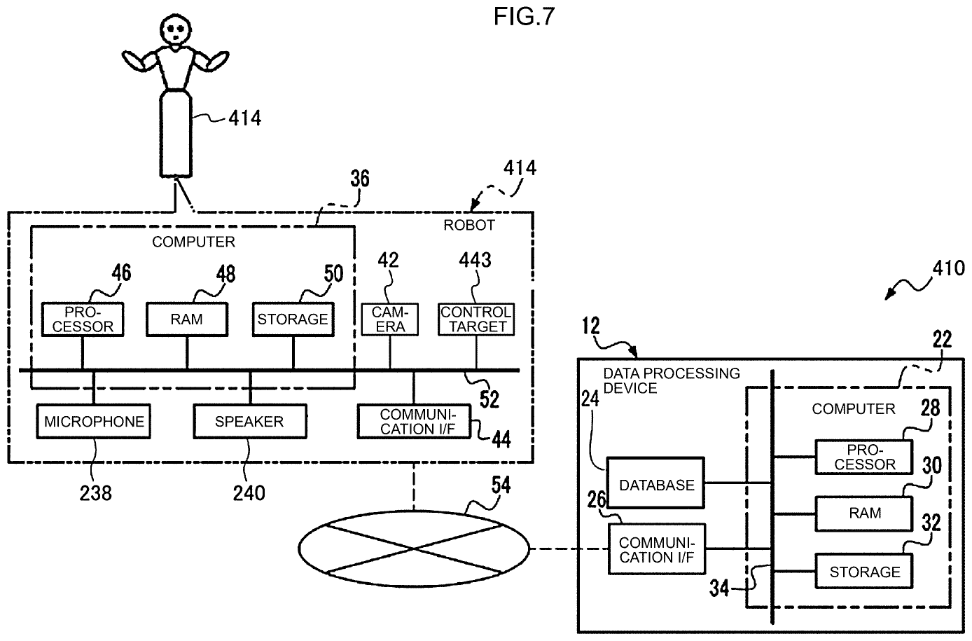

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

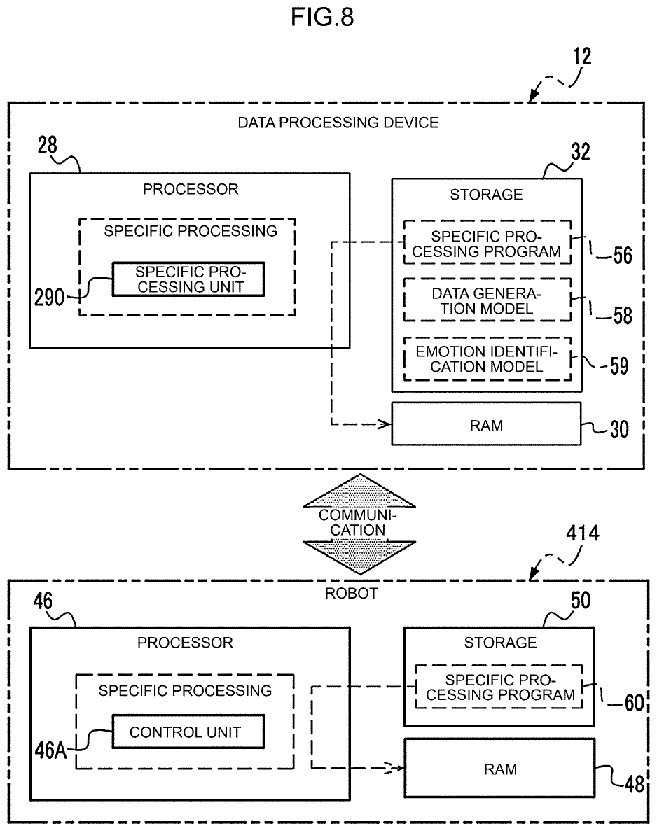

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned acquisition unit, analysis unit, provision unit, specifying unit, feedback unit, and praising unit is implemented by at least one of, for example, the robot 414 and the data processing apparatus 12. For example, the acquisition unit captures the inside of the user's mouth using the camera of the robot 414. The analysis unit is implemented by a specific processing unit 290 of the data processing apparatus 12 and analyzes the acquired video. The provision unit, as a processing unit for notifying the user of the analysis result, is implemented by a control unit 46A of the robot 414. The specifying unit is implemented by the specific processing unit 290 of the data processing apparatus 12 and identifies unbrushed areas. The feedback unit is implemented by the control unit 46A of the robot 414 and provides feedback to the user. The praising unit is implemented by the specific processing unit 290 of the data processing apparatus 12 and generates a message to praise the user. The correspondence between each unit and the device or control unit is not limited to the examples described above and various modifications are possible.

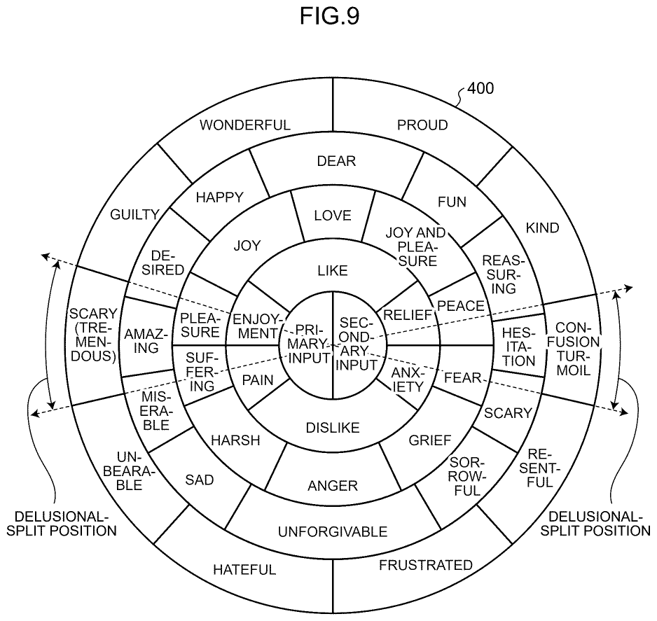

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

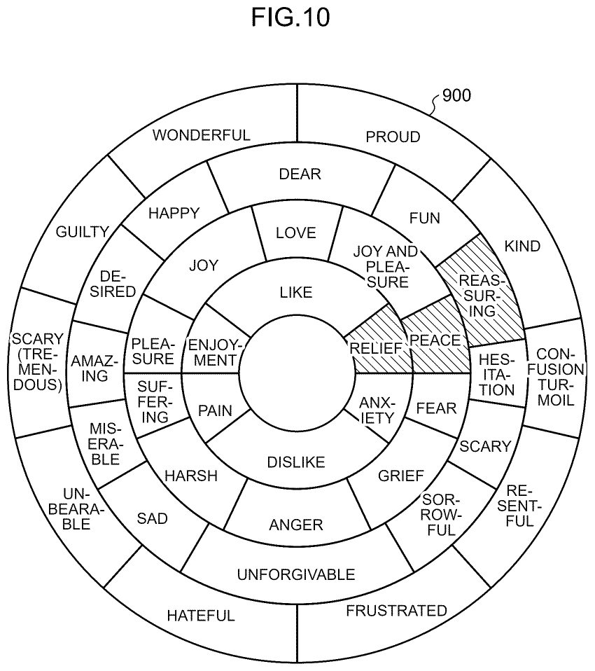

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1)A system comprising: an acquisition unit configured to acquire a video of a user's tooth brushing; an analysis unit configured to analyze the video acquired by the acquisition unit; and a provision unit configured to provide the analysis result obtained by the analysis unit to the user.
(Supplementary Note 2)The system according to Supplementary Note 1, further comprising a specifying unit configured to identify unbrushed areas.
(Supplementary Note 3)The system according to Supplementary Note 1, further comprising a feedback unit configured to provide feedback to the user.
(Supplementary Note 4)The system according to Supplementary Note 1, further comprising a praising unit configured to praise the user.
(Supplementary Note 5)The system according to Supplementary Note 1, wherein the acquisition unit is configured to capture the inside of the user's mouth using a smartphone camera.
(Supplementary Note 6)The system according to Supplementary Note 1, wherein the analysis unit is configured to analyze the condition of the user's teeth from the video and identify unbrushed areas.
(Supplementary Note 7)The system according to Supplementary Note 1, wherein the provision unit is configured to notify the user of the identified unbrushed areas.
(Supplementary Note 8)The system according to Supplementary Note 1, wherein the provision unit is configured to display a message generated by AI to praise the user when the user brushes properly.
(Supplementary Note 9)The system according to Supplementary Note 1, wherein the acquisition unit is configured to estimate the user's emotion and adjust the timing of acquiring the tooth brushing video based on the estimated emotion.
(Supplementary Note 10)The system according to Supplementary Note 1, wherein the acquisition unit is configured to analyze the user's past tooth brushing history and select an appropriate acquisition method.
(Supplementary Note 11)The system according to Supplementary Note 1, wherein the acquisition unit is configured to perform filtering based on the health condition inside the user's mouth when acquiring the tooth brushing video.
(Supplementary Note 12)The system according to Supplementary Note 1, wherein the acquisition unit is configured to estimate the user's emotion and determine the priority of the video to be acquired based on the estimated emotion.
(Supplementary Note 13)The system according to Supplementary Note 1, wherein the acquisition unit is configured to preferentially acquire relevant videos based on the user's geographic location information when acquiring the tooth brushing video.
(Supplementary Note 14)The system according to Supplementary Note 1, wherein the acquisition unit is configured to analyze the user's social media activity and acquire related videos when acquiring the tooth brushing video.
(Supplementary Note 15)The system according to Supplementary Note 1, wherein the analysis unit is configured to estimate the user's emotion and adjust the method of presenting the analysis based on the estimated emotion.
(Supplementary Note 16)The system according to Supplementary Note 1, wherein the analysis unit is configured to adjust the level of detail of the analysis based on the health condition of the teeth during analysis.
(Supplementary Note 17)The system according to Supplementary Note 1, wherein the analysis unit is configured to apply different analysis algorithms according to the category of the teeth during analysis.
(Supplementary Note 18)The system according to Supplementary Note 1, wherein the analysis unit is configured to estimate the user's emotion and adjust the length of the analysis based on the estimated emotion.
(Supplementary Note 19)The system according to Supplementary Note 1, wherein the analysis unit is configured to determine the priority of the analysis based on the frequency of tooth brushing during analysis.
(Supplementary Note 20)The system according to Supplementary Note 1, wherein the analysis unit is configured to adjust the order of analysis based on the relevance of the teeth during analysis.
(Supplementary Note 21)The system according to Supplementary Note 1, wherein the provision unit is configured to estimate the user's emotion and adjust the method of provision based on the estimated emotion.
(Supplementary Note 22)The system according to Supplementary Note 1, wherein the provision unit is configured to adjust the level of detail of provision based on the importance of the analysis result during provision.
(Supplementary Note 23)The system according to Supplementary Note 1, wherein the provision unit is configured to apply different provision algorithms according to the category of the analysis result during provision.
(Supplementary Note 24)The system according to Supplementary Note 1, wherein the provision unit is configured to estimate the user's emotion and adjust the timing of provision based on the estimated emotion.
(Supplementary Note 25)The system according to Supplementary Note 1, wherein the provision unit is configured to determine the priority of provision based on the submission timing of the analysis result during provision.
(Supplementary Note 26)The system according to Supplementary Note 1, wherein the provision unit is configured to adjust the order of provision based on the relevance of the analysis result during provision.
(Supplementary Note 27)The system according to Supplementary Note 2, wherein the specifying unit is configured to estimate the user's emotion and adjust the method of identifying unbrushed areas based on the estimated emotion.
(Supplementary Note 28)The system according to Supplementary Note 2, wherein the specifying unit is configured to improve the accuracy of identification based on the health condition of the teeth when identifying unbrushed areas.
(Supplementary Note 29)The system according to Supplementary Note 2, wherein the specifying unit is configured to estimate the user's emotion and determine the priority of identification based on the estimated emotion.
(Supplementary Note 30)The system according to Supplementary Note 2, wherein the specifying unit is configured to apply different identification algorithms according to the category of the teeth when identifying unbrushed areas.
(Supplementary Note 31)The system according to Supplementary Note 3, wherein the feedback unit is configured to estimate the user's emotion and adjust the method of presenting feedback based on the estimated emotion.
(Supplementary Note 32)The system according to Supplementary Note 3, wherein the feedback unit is configured to adjust the level of detail of feedback based on the importance of the analysis result during feedback.
(Supplementary Note 33)The system according to Supplementary Note 3, wherein the feedback unit is configured to estimate the user's emotion and adjust the length of feedback based on the estimated emotion.
(Supplementary Note 34)The system according to Supplementary Note 3, wherein the feedback unit is configured to determine the priority of feedback based on the submission timing of the analysis result during feedback.
(Supplementary Note 35)The system according to Supplementary Note 4, wherein the praising unit is configured to estimate the user's emotion and adjust the method of praising based on the estimated emotion.
(Supplementary Note 36)The system according to Supplementary Note 4, wherein the praising unit is configured to select an appropriate method of praising by referring to the user's past tooth brushing history when praising.
(Supplementary Note 37)The system according to Supplementary Note 4, wherein the praising unit is configured to estimate the user's emotion and adjust the number of times of praising based on the estimated emotion.
(Supplementary Note 38)The system according to Supplementary Note 4, wherein the praising unit is configured to select an appropriate method of praising based on the user's geographic location information when praising.

What is claimed is:

1. A system comprising:
circuitry configured to:
acquire, from a client terminal communicatively coupled to the system via a packet-switched network, visual data captured by the client terminal;
apply a trained inference model to the visual data to generate assessment data identifying one or more regions within the visual data that satisfy a predetermined condition; and
transmit, to the client terminal via the packet-switched network, result data based on the assessment data.

2. The system according to claim 1, wherein the circuitry is further configured to identify, based on the assessment data, one or more target regions within the visual data where the predetermined condition is not satisfied.

3. The system according to claim 1, wherein the circuitry is further configured to generate, using a natural language generation model, feedback data characterizing the assessment data, and wherein the result data comprises the feedback data.

4. The system according to claim 1, wherein the circuitry is further configured to generate, using a data generation model, a positive reinforcement message when the assessment data indicates that the one or more regions satisfy a quality threshold.

5. The system according to claim 1, wherein the visual data comprises image frames captured by an image sensor of the client terminal, the image sensor comprising a complementary metal-oxide-semiconductor sensor or a charge-coupled device sensor.

6. The system according to claim 1, wherein the trained inference model comprises a convolutional neural network or a Vision Transformer configured to estimate, at a pixel level, whether each region within the visual data satisfies the predetermined condition.

7. The system according to claim 6, wherein the trained inference model outputs a binary mask identifying the one or more regions and a score map indicating a probability value for each pixel.

8. The system according to claim 1, wherein the circuitry is further configured to estimate an emotion of a user of the client terminal using an emotion identification model, and adjust a timing of acquiring the visual data based on the estimated emotion.

9. The system according to claim 1, wherein the circuitry is further configured to analyze historical visual data previously acquired from the client terminal to select an acquisition method for the visual data.

10. The system according to claim 1, wherein the circuitry is further configured to perform filtering on the visual data based on a health condition determined from the visual data.

11. The system according to claim 1, wherein the circuitry is further configured to estimate an emotion of a user of the client terminal and determine a priority of the visual data to be acquired based on the estimated emotion.

12. The system according to claim 1, wherein the circuitry is further configured to preferentially acquire relevant visual data based on geographic location information of a user of the client terminal.

13. The system according to claim 1, wherein the circuitry is further configured to estimate an emotion of a user of the client terminal and adjust a method of presenting the result data based on the estimated emotion.

14. The system according to claim 1, wherein the circuitry is further configured to adjust a level of detail of the assessment data based on a severity of the predetermined condition identified in the visual data.

15. The system according to claim 1, wherein the circuitry is further configured to apply different analysis algorithms according to a category of the one or more regions during generation of the assessment data.

16. The system according to claim 1, wherein the circuitry is further configured to determine a priority of analysis based on a frequency at which the visual data is acquired from the client terminal.

17. The system according to claim 1, wherein the circuitry is further configured to adjust an order of analysis of the one or more regions based on a relevance between the regions.

18. A system comprising:
a communication interface communicatively coupled to a packet-switched network;
a processor;
a random access memory;
a memory storing a trained inference model and an emotion identification model; and
a database connected to the processor via a bus,
wherein the processor is configured to:
receive, via the communication interface, visual data captured by a client terminal communicatively coupled to the system via the packet-switched network;
apply the trained inference model to the visual data to generate assessment data identifying one or more regions within the visual data that satisfy a predetermined condition;
estimate an emotion of a user of the client terminal using the emotion identification model;
generate, based on the assessment data and the estimated emotion, result data adapted to the estimated emotion; and
transmit, via the communication interface, the result data to the client terminal.

19. The system according to claim 18, wherein the processor is further configured to store the visual data and the assessment data in the database, and to analyze historical assessment data retrieved from the database to adjust a method of generating the result data.

20. A method performed by circuitry of a system, the method comprising:
acquiring, from a client terminal communicatively coupled to the system via a packet-switched network, visual data captured by the client terminal;
applying a trained inference model to the visual data to generate assessment data identifying one or more regions within the visual data that satisfy a predetermined condition; and
transmitting, to the client terminal via the packet-switched network, result data based on the assessment data.
